(19) United States
(12) Patent Application Publication
(10) Pub. No.: US 2022/0311109 A1
(43) Pub. Date: Sep. 29, 2022

(54) Batteries that Deactivate in a Conductive Aqueous Medium and Methods of Making The Same

(71) Applicant: Fenwood Labs Inc., Fairfield, CT (US)

(72) Inventors: Bryan Laulicht, Danbury, CT (US); Jonah Myerberg, Lexington, MA (US); Ravikumar Vasudevan, Fairfield, CT (US); Zachary A. Kelly, Middletown, CT (US); Jeff M. Karp, Brookline, MA (US); Robert Langer, Newton, MA (US)

(73) Assignee: Fenwood Labs Inc., Fairfield, CT (US)

(21) Appl. No.: 17/618,364

(22) PCT Filed: Jun. 10, 2020
(86) PCT No.: PCT/US20/36963

§ 371 Date: Dec. 10, 2021

Related U.S. Application Data
(60) Provisional application No. 62/898,140, filed on Sep. 10, 2019.
(60) Provisional application No. 62/861,280, filed on Jun. 13, 2019.

(51) Int. Cl. H01M 50/574; H01M 50/109; H01M 50/56; H01M 50/197; H01M 50/198; H01M 50/548; H01M 50/124

(52) U.S. Cl. CPC H01M 50/574; H01M 50/109; H01M 50/56; H01M 50/197; H01M 50/198; H01M 50/548; H01M 50/1243

(57) ABSTRACT

The present disclosure provides batteries that have a reduced risk or no risk of gastrointestinal damage in a conductive aqueous environment, such as when accidentally swallowed. The batteries of the present disclosure advantageously stop producing significant current flow shortly after contact with a conductive aqueous medium, including the conductive aqueous medium of a wet tissue environment such as that found in the GI tract. The present disclosure further provides multi-layered laminate materials useful for manufacturing such batteries and methods for making the batteries. The batteries are, in some embodiments, 3 V or 1.5 V coin or button cell-type batteries.

### CROSS-REFERENCE TO RELATED APPLICATIONS

This application claims the benefit of priority to U.S. Provisional Application Nos. 62/861,280, filed Jun. 13, 2019; and 62/898,140, filed Sep. 10, 2019, each of which is incorporated by reference herein in its entirety for any purpose.

### FIELD

The present disclosure is generally directed to batteries, and more particularly, batteries that have a reduced risk or no risk of gastrointestinal damage in a conductive aqueous environment, such as when accidentally swallowed.

### BACKGROUND

Billions of batteries are sold each year to power portable electronic devices including, for example, remote controls, flashlights, cameras, car key fobs, calculators, scales, musical greeting cards, glucometers, watches, thermometers, virtual pet devices, hearing aids, laser pointers, games, toys, and the like. Unfortunately, children, pets, and the elderly are at risk of ingesting batteries due to their widespread presence in the home and society at large.

Ingestion of batteries causes devastating injuries. Gastrointestinal (GI) obstruction is a risk from ingestion of any foreign object. But battery ingestion is far more severe than ingestion of comparably sized objects, such as coins, because of tissue damage caused when the battery discharges in the GI tract. Current flow in conductive GI fluids can cause electrolysis and generate hydroxide ions, thereby creating long-term tissue damage in the digestive tract. Damage from ingested batteries has caused acute injuries including esophageal and other GI perforations, tracheoesophageal fistulae, atrioesophageal fistulae, esophageal stenosis, esophageal stricture, chemical burns, and vocal cord paralysis. These injuries can cause permanent, life-altering damage and even death. Case studies have shown that GI perforation in humans can occur as soon as five hours after battery ingestion. In pets, severe GI damage occurs even more quickly, with reports of transmural esophageal necrosis within one hour of ingestion in dogs and within two to four hours in cats.

As manufacturers create more powerful and more energy dense batteries in smaller casings, battery ingestion and injury is on the rise. The increase in battery power results in a corresponding increase in severity of injuries and mortality from battery ingestion. Though safety standards now regulate locked battery compartments in toys, little has been done to the design of the batteries themselves to make them safer. Indeed, the incidence of battery ingestion-related injuries has continued to rise even after the introduction of tamper proof packaging in batteries and locked battery compartments, as shown in FIG. 1.

Accordingly, there is a need to provide batteries that do not cause significant tissue damage when accidentally ingested. More particularly, there is a need to provide batteries that do not generate a significant current flow for long periods of time when in a conductive aqueous environment, such as a GI tract.

### SUMMARY

Embodiment 1. A battery comprising:

an anode case;

a cathode case comprising an inner conductive layer, an outer conductive layer, and an insulating layer between the inner and the outer conductive layers,

an electrochemical cell comprising an anode, a cathode, and a separator positioned between the anode and the cathode; and

a gasket between the anode case and the cathode case;

wherein the inner and the outer conductive layers are in electrical contact through at least one bridge.

Embodiment 2. The battery of embodiment 1, wherein after the battery contacts a conductive aqueous medium, the electrical contact between the inner conductive layer and the outer conductive layer through the at least one bridge is reduced or severed.

Embodiment 3. The battery of embodiment 1 or embodiment 2, wherein the at least one bridge comprises a material that is capable of electrochemical oxidation when a transient conductive pathway is formed between the anode and the cathode through a conductive aqueous medium.

Embodiment 4. The battery of any one of the preceding embodiments, wherein the at least one bridge provides the electrical contact at a point or points, through a seam, and/or through a channel.

Embodiment 5. The battery of any one of the preceding embodiments, wherein the at least one bridge comprises a portion of the inner conductive layer in electrical contact with a portion of the outer conductive layer.

Embodiment 6. The battery of any one of the preceding embodiments, wherein the electrochemical cell has a voltage of 1.2 V or more.

Embodiment 7. The battery of any one of the preceding embodiments, wherein the at least one bridge comprises the same material as the inner conductive layer and/or the outer conductive layer.

Embodiment 8. The battery of any one of the preceding embodiments, wherein the at least one bridge comprises a conductive wire, a conductive strip, or a conductive sheet.

Embodiment 9. The battery of any one of the preceding embodiments, wherein the cathode case comprises a bottom, an annular side, and a rim, and wherein the at least one bridge is positioned at the bottom, the annular side, the rim, or any combination thereof.

Embodiment 10. The battery of embodiment 9, wherein the at least one bridge is positioned along the rim of the cathode case.

Embodiment 11. The battery of embodiment 9 or embodiment 10, wherein the at least one bridge is created by crimping the inner conductive layer and outer conductive layer together in at least one location along the rim.

Embodiment 12. The battery of any one of embodiments 9 to 11, wherein the at least one bridge comprises a plurality of extensions, each extension comprising:

a) a portion of the inner conductive layer extending over the insulating layer to electrically contact the outer conductive layer along the rim of the cathode case, or

b) a portion of the outer conductive layer extending over the insulating layer to electrically contact the inner conductive layer along the rim of the cathode case, or

c) a combination of a) and b).

Embodiment 13. The battery of any one of embodiments 9 to 12, wherein the at least one bridge comprises at least one seam along the rim of the cathode case, the at least one seam comprising: a) the inner conductive layer extending over the insulating layer to electrically contact the outer conductive layer at the rim of the cathode case, or b) the outer conductive layer extending over the insulating layer to electrically contact the inner conductive layer at the rim of the cathode case, or c) a combination of a) and b).

Embodiment 14. The battery of any one of embodiments 9 to 13, wherein the at least one bridge is positioned on the annular side of the cathode case to form the electrical contact between the inner conductive layer and the outer conductive layer through the insulating layer of the cathode case.

Embodiment 15. The battery of any one of embodiments 9 to 14, wherein the at least one bridge is positioned on the bottom of the cathode case to form the electrical contact between the inner conductive layer and the outer conductive layer through the insulating layer of the cathode case and the bridge.

Embodiment 16. The battery of any one of embodiments 1 to 8, wherein the bridge is positioned through the gasket such that it contacts the inner conductive layer and the outer conductive layer to form the electrical contact.

Embodiment 17. The battery of any one of the preceding embodiments, wherein the at least one bridge is stamped, ultrasonically welded, laser welded, sputtered, physical vapor deposited, plated, soldered, brazened, thermoformed, printed with conductive ink or otherwise affixed to the inner conductive layer and/or the outer conductive layer.

Embodiment 18. The battery of any one of the preceding embodiments, wherein the inner conductive layer comprises aluminum, stainless steel, chromium, tungsten, gold, vanadium, nickel, titanium, tantalum, silver, copper, magnesium, zinc, an alloy thereof, or a combination of any two or more thereof.

Embodiment 19. The battery of any one of the preceding embodiments, wherein the inner conductive layer comprises aluminum or an aluminum alloy.

Embodiment 20. The battery of any one of the preceding embodiments, wherein the outer conductive layer comprises stainless steel, nickel, gold, aluminum, titanium, an alloy thereof, or a combination of any two or more thereof.

Embodiment 21. The battery of embodiment 20, wherein the stainless steel comprises SS304, SS316, SS430, duplex 2205, duplex 2304, duplex 2507, or one or more other steel with a chromium content equal to or greater than 10% by weight and/or a nickel content equal to or greater than 0.1% by weight.

Embodiment 22. The battery of any one of the preceding embodiments, wherein the inner conductive layer and/or the outer conductive layer comprises a conductive composite.

Embodiment 23. The battery of embodiment 22, wherein the conductive composite comprises conductive particles embedded in a non-conductive medium to form an overall conductive film that is incorporated into the cathode case as the inner conductive layer and/or the outer conductive layer.

Embodiment 24. The battery of embodiment 23, wherein the conductive particles comprise carbon black, carbon nanotubes, graphene, graphite, carbon fibers, or any combination of any two or more thereof.

Embodiment 25. The battery of any one of the preceding embodiments, wherein the insulating layer has a breakdown voltage greater than the open circuit voltage of the battery.

Embodiment 26. The battery of any one of the preceding embodiments, wherein the insulating layer has a dielectric breakdown strength of at least 50V per 25 micron of insulating layer thickness.

Embodiment 27. The battery of any one of the preceding embodiments, wherein the insulating layer or the insulating material comprises a hydrophobic polymer, a natural rubber, a cellulose acetate, a paper dielectric, a ceramic, a metal oxide, a nitride, a carbide, or a combination of any two or more thereof.

Embodiment 28. The battery of embodiment 27, wherein the hydrophobic polymer comprises a polyethylene terephthalate, a polytetrafluoroethylene, a fluorinated ethylene propylene, a perfluoroalkoxyalkane, a polyvinyl fluoride, a polyvinylidine difluoride, a polyphenylene sulfide, a polypropylene, a polyurethane, a polyimide, a polyetherimide, a dimethylpolysiloxane, styrene-ethylene-butylene-styrene, thermoplastic polyurethanes, thermoplastic polyolefins, thermoplastic polyolefins, or a combination of any two or more thereof.

Embodiment 29. The battery of embodiment 27 or embodiment 28, wherein the hydrophobic polymer has a saturation equilibrium water permeability of up to about 2%, about 1.5%, about 1.25%, about 0.75%, about 0.5%, about 0.25%, or about 0.1%.

Embodiment 30. The battery of any one of embodiments 27 to 29, wherein the hydrophobic polymer has a glass transition temperature (Tg) of at least 80° C., at least 130° C., or at least 150° C.

Embodiment 31. The battery of any one of embodiments 27 to 30, wherein the metal oxide comprises silicon dioxide, aluminum oxide, nickel oxide, chromium oxide, or a combination of any two or more thereof.

Embodiment 32. The battery of any one of the preceding embodiments, wherein the insulating layer comprises multiple insulating layers.

Embodiment 33. The battery of any one of the preceding embodiments, wherein the insulating layer comprises: a) a multilayered construction comprising an adhesive layer in contact with the outer conductive layer, b) a multilayered construction comprising an adhesive layer in contact with the inner conductive layer, or c) a combination of a) and b).

Embodiment 34. The battery of embodiment 33, wherein the adhesive layer comprises a pressure-sensitive adhesive, a rubber-based adhesive, an epoxy, a polyurethane, a silicone adhesive, a phenolic resin, a UV curable adhesive, an acrylate adhesive, a laminating adhesive, a fluoropolymer, or any combination of two or more thereof.

Embodiment 35. The battery of embodiment 34, wherein the laminating adhesive comprises a low or a high density polyethylene, a polyolefin, a polyolefin derivative, an acid-containing adhesive, an ionomer, a terpolymer of ethylene, an acrylate, or an ethylene-vinyl acetate.

Embodiment 36. The battery of embodiment 35, wherein the acid-containing adhesive comprises EAA, EMAA, an ionomer, a terpolymer of ethylene, an acid, or an acrylate.

Embodiment 37. The battery of any one of the preceding embodiments, wherein the insulating layer comprises a 25-40 μm layer of acrylic pressure-sensitive adhesive in contact with the outer conductive layer, a 1-12.5 μm layer of laminate adhesive in contact with the inner conductive layer, and a 1-25 μm layer of polyethylene terephthalate between the two adhesive layers.

Embodiment 38. The battery of any one of the preceding embodiments, wherein the insulating layer further comprises an internal support member.

Embodiment 39. The battery of any one of the preceding embodiments, wherein the insulating layer comprises an internal support member coated with an insulating material.

Embodiment 40. The battery of embodiment 38 or embodiment 39, wherein the internal support member comprises a metal, a polymer, or a combination thereof.

Embodiment 41. The battery of embodiment 40, wherein the metal comprises stainless steel, nickel, copper, gold, aluminum, titanium, zinc, an alloy thereof, or a combination of any two or more thereof.

Embodiment 42. The battery of embodiment 41, wherein the stainless steel comprises SS304, SS316, SS430, duplex 2205, duplex 2304, duplex 2507, or one or more other steel with a chromium content equal to or greater than 10% by weight and/or a nickel content equal to or greater than 0.1% by weight.

Embodiment 43. The battery of any one of the preceding embodiments, wherein the at least one bridge comprises a stainless steel, magnesium, aluminum, manganese, zinc, chromium, cobalt, nickel, tin, antimony, bismuth, copper, silicon, silver, zirconium, or a combination of any two or more thereof.

Embodiment 44. The battery of embodiment 43, wherein the stainless steel comprises SS304, SS316, SS430, a duplex stainless steel, or one or more other steel with a chromium content equal to or greater than 10% by weight and/or a nickel content equal to or greater than 0.1% by weight.

Embodiment 45. The battery of any one of the preceding embodiments, wherein the outer conductive layer has a uniform or varying thickness ranging from about 100 nm to about 400 μm, about 100 nm to about 350 μm, about 1 μm to about 350 μm, about 200 μm to about 350 μm, about 1 μm to about 50 μm, about 5 μm to about 50 μm, about 50 μm to 250 μm, or about 5 μm to about 200 μm.

Embodiment 46. The battery of any one of the preceding embodiments, wherein the inner conductive layer has a uniform or variable thickness ranging from about 100 nm to about 400 μm, about 100 nm to about 350 μm, about 1 μm to about 350 μm, about 200 μm to about 350 μm, about 1 μm to about 50 μm, about 5 μm to about 50 μm, about 50 μm to 250 μm, or about 5 μm to about 200 μm.

Embodiment 47. The battery of any one of the preceding embodiments, wherein the insulating layer has a uniform or varying thickness ranging from about 100 nm to about 400 μm, about 100 nm to about 350 μm, about 1 μm to about 350 μm, about 200 μm to about 350 μm, about 1 μm to about 50 μm, about 5 μm to about 50 μm, about 50 μm to 250 μm, or about 5 μm to about 200 μm.

Embodiment 48. The battery of any one of the preceding embodiments, wherein the at least one bridge has a uniform or varying thickness ranging from about 100 nm to about 50 μm.

Embodiment 49. The battery of any one of the preceding embodiments, wherein the outer conductive layer, the insulating layer, and the inner conductive layer have a combined thickness ranging from about 150 μm to about 450 μm, or about 200 μm to about 360 μm.

Embodiment 50. The battery of any one of the preceding embodiments, wherein the electrical contact is measured by determining the electrical resistance between the inner conductive layer and the outer conductive layer through the at least one bridge.

Embodiment 51. The battery of any one of the preceding embodiments, wherein the electrical contact is measured by determining the electrical conductivity between the inner conductive layer and the outer conductive layer through the at least one bridge.

Embodiment 52. The battery of embodiment 50 or embodiment 51, wherein the electrical resistance between the inner conductive layer and the outer conductive layer is less than 1 ohm, from 0.01 ohm to 0.1 ohm, from 0.01 ohm to 1 ohm, from 1 ohm to 10 ohms, or from 10 ohms to 100 ohms prior to contact of the at least one bridge with a conductive pathway through a conductive aqueous medium.

Embodiment 53. The battery of any one of embodiments 2 to 52, wherein the contact with the conductive aqueous medium comprises placement of the battery on a hydrated tissue such that the hydrated tissue contacts both at least one part of the anode case and at least one bridge to form a conductive pathway.

Embodiment 54. The battery of embodiment 53, wherein the hydrated tissue is hydrated pig esophageal tissue.

Embodiment 55. The battery of any one of embodiments 2 to 54, wherein the contact with the conductive aqueous medium comprises immersion of the battery in the conductive aqueous medium, and the conductive aqueous medium contacts both at least one part of the anode case and at least one bridge to form a transient conductive pathway between the anode and the cathode.

Embodiment 56. The battery of any one of the preceding embodiments, wherein after immersion in a conductive aqueous medium for 120 minutes, the dry battery closed circuit voltage is reduced to 1.23 V or less when the dry battery closed circuit voltage is measured in series with a 15 kohm resistor.

Embodiment 57. The battery of any one of the preceding embodiments, wherein after immersion for 120 minutes in 0.85% saline solution, the dry battery closed circuit voltage is reduced to 1.23 V or less when the dry battery closed circuit voltage is measured in series with a 15 kohm resistor.

Embodiment 58. The battery of any one of the preceding embodiments, wherein after immersion for 120 minutes, in 25% Ringers solution, the dry battery closed circuit voltage is reduced to 1.23 V or less when the dry battery closed circuit voltage is measured in series with a 15 kohm resistor.

Embodiment 59. The battery of any one of the preceding embodiments, wherein, after immersion for 60 minutes, or for 20 minutes, or for 10 min in 0.85% saline solution or in 25% Ringers solution, the dry battery voltage is reduced to 1.23 V or less when the dry battery closed circuit voltage is measured in series with a 15 kohm resistor,

Embodiment 60. The battery of any one of the preceding embodiments, wherein the battery is a button or a coin cell-type battery.

Embodiment 61. The battery embodiment 60, wherein the battery is a 3 volt or a 1.5 volt button or coin cell battery.

Embodiment 62. The battery of embodiment 60 or embodiment 61, wherein the battery is a CR927, CR1025, CR1130, CR1216, CR1220, CR1225, CR1616, CR1620, CR1625, CR1632, CR2012, CR2016, CR2025, CR2032, CR2320, BR2335, CR2354, CR2412, CR2430, CR2450, CR2477, CR2507, CR3032, or CR11108 lithium coin cell battery or a SR41, SR43, SR44, SR45, SR48, SR54, SR55. SR57, SR58, SR59, SR60, SR63, SR64, SR65. SR66, SR67, SR68, SR69, S516, SR416, SR731. SR512, SR714, SR712 silver oxide coin cell battery or LR41, LR44, LR54, or LR66 alkaline coin cell battery.

Embodiment 63. The battery of embodiment 60 or embodiment 61, wherein the battery is a CR2032, CR2016, or CR2025 lithium coin cell battery.

Embodiment 64. The battery of any one of embodiments 1 to 59, wherein the battery is a AAA, AA, A, E 90/N, 4001, 810, 910A, AM5, LR1, MN9100, or UM-5 cylindrical battery.

Embodiment 65. The battery of any one embodiment 2 to 64, wherein the conductive aqueous medium is an about 0.85% saline solution having a starting pH of about 5 to about 7.5, and after immersion of the battery in the saline solution, the average pH of the saline solution, sampled at 5-minute intervals, over a 60-minute time period does not exceed an average pH of about 10, about 9.5, about 9, about 8.5, or about 8.

Embodiment 66. The battery of any one of the preceding embodiments, wherein after immersion of the battery in 20 mL of a 0.85% w/w saline solution having a pH of 5.5 to 7 at room temperature for at least 1 hour, the electrical resistance between the inner conductive layer and the outer conductive layer is greater than 500 ohms, greater than 50 kohms, or greater than 500 kohms.

Embodiment 67. The battery of any one of the preceding embodiments, wherein after immersion of the battery in about 20 mL of a 0.85% w/w saline solution having a pH of about 5.5 to about 7 at room temperature for at least about 30 seconds to about 2 hours, the electrical resistance between the inner conductive layer and the outer conductive layer is greater than about 500 ohms, greater than about 50 kohms, greater than about 500 kohms

Embodiment 68. The battery of any one of the preceding embodiments, wherein the breakdown voltage of the insulating layer is greater than about 3.3 Volts.

Embodiment 69. The battery of any one of the preceding embodiments, wherein after immersion of the battery in about 20 mL of a 0.85% w/w saline solution having a pH of about 5.5 to about 7 at room temperature for at least 1 hour, the current output of the battery is less than about 0.1 mA, less than about 0.01 mA, or less than about 1 μA when the current output of the battery is measured in series with about a 1 kohm resistor, or with about a 15 kohm resistor, or with about a 100 kohm resistor.

Embodiment 70. The battery of any one of the preceding embodiments wherein the internal resistance of the battery does not increase by more than about 500 ohms, or does not increase by more than about 100 ohms, or does not increase by more than about 50 ohms, or does increase by more than about 20 ohms after being exposed to a non-conductive aqueous medium from about 1 min to about 180 minutes, or from about 1 min to about 60 min, or from about 1 min to about 10 min.

Embodiment 71. The battery of any one of the preceding embodiments wherein the internal resistance of the battery does not increase by more than about 500 ohms, or does not increase by more than about 100 ohms, or does not increase by more than about 50 ohms, or does increase by more than about 20 ohms when stored in an environment having a temperature in the range of −20° C. to 60° C.

Embodiment 72. The battery of embodiment 71 wherein the battery is stored in the environment having a temperature in the range of −20° C. to 60° C. for more than about 2 hours, or from about 2 hours to about 60 days, or from about 120 hours to about 20 days, or from about 7 days to about 60 days.

Embodiment 73. The battery of embodiment 71 or 72 wherein the battery is stored in an environment having a temperature in the range of about 40° C. to about 60° C. for about 2 hours to about 7 days.

Embodiment 74. The battery of any one of the preceding embodiments wherein the internal resistance of the battery does not increase by more than about 500 ohms, or does not increase by more than about 100 ohms, or does not increase by more than about 50 ohms, or does increase by more than about 20 ohms after being stored in an environment having relative humidity of about 95% or lower.

Embodiment 75. The battery of any one of embodiments 71, 72 or 74 wherein the battery is stored in the environment having relative humidity of about 95% or lower for more than about 2 hours, or from about 2 hours to about 60 days, or from about 2 hours to about 20 days, or from about 120 hours to about 7 days, or from about 7 days to about 60 days.

Embodiment 76. The battery of any one of embodiments 71 to 75 wherein the battery is stored in an environment having relative humidity of about 30% to about 90% for about 2 hours to about 7 days.

Embodiment 77. The battery of embodiment 71 to 76 wherein the battery is stored in an environment having relative humidity of from about 30% to about 90% and a temperature in the range of about 40° C. to about 45° C. for about 2 hours to about 7 days.

Embodiment 78. A multi-layer laminate for an electrode case comprising: a first conductive layer, a second conductive layer, and an insulating layer between the first and the second conductive layers.

Embodiment 79. The laminate of embodiment 78, wherein the first and the second conductive layers are in electrical contact after a physical or chemical process to form at least one bridge.

Embodiment 80. The laminate of embodiment 78, wherein when the laminate is used in a battery case and after contact of the at least one bridge with a conductive aqueous medium, the electrical contact between the first and the second conductive layers is reduced or severed.

Embodiment 81. The laminate of any one of embodiments 78 to 80, wherein the laminate further comprises: a) an adhesive layer between the first conductive layer and the non-conductive layer, b) an adhesive layer between the second conductive layer and the non-conductive layer, or c) both a) and b).

Embodiment 82. The laminate of any one of embodiments 78 to 81, wherein the first conductive layer comprises aluminum, stainless steel, chromium, tungsten, titanium, vanadium, nickel, copper, magnesium, molybdenum, zinc, or a combination of any two or more thereof.

Embodiment 83. The laminate of any one of embodiments 78 to 82, wherein the second conductive layer comprises stainless steel, aluminum, titanium, nickel, copper, molybdenum, zinc, or a combination of any two or more thereof.

Embodiment 84. The laminate of embodiment 83, wherein the stainless steel comprises SS304, SS316, SS430, a duplex stainless steel, steel with a chromium contact greater than or equal to about 10% by weight and a nickel content greater than or equal to about 0.1% by weight, or a combination of any two or more thereof.

Embodiment 85. The laminate of any one of embodiments 78 to 84, wherein the insulating layer comprises a hydrophobic polymer, a natural rubber, a silicone elastomer, a cellulose acetate, a paper dielectric, a ceramic, a metal oxide, a nitride, a carbide, or a combination of any two or more thereof.

Embodiment 86. The laminate of embodiment 85, wherein the hydrophobic polymer is a polyethylene terephthalate, a polytetrafluoroethylene, a fluorinated ethylene propylene, a polyvinyl fluoride, a polyvinylidine difluoride, a polypropylene, a polyurethane, a polyimide, a dimethylpolysiloxane, an anodized aluminum, or a combination of any two or more thereof.

Embodiment 87. The laminate of embodiment 86, wherein the metal oxide is aluminum oxide, nickel oxide, chromium oxide, or a combination of any two or more thereof.

Embodiment 88. The laminate of any one of embodiments 78 to 87, wherein the at least one bridge comprises a material that is capable of electrochemical oxidation when the laminate is used in a battery case and after contact of the at least one bridge with a conductive aqueous medium.

Embodiment 89. The laminate of any one of embodiments 78 to 88, wherein the at least one bridge comprises a stainless steel, aluminum, chromium, nickel, copper, magnesium, zinc, or a combination of any two or more thereof.

Embodiment 90. The laminate of any one of embodiments 78 to 89, wherein the first conductive layer has a uniform or variable thickness ranging from about 1 μm to about 400 μm, about 1 μm to about 350 μm, about 200 μm to about 350 μm, about 1 μm to about 50 μm, about 5 μm to about 50 μm, about 50 μm to 250 μm, or about 5 μm to about 200 μm.

Embodiment 91. The laminate of any one of embodiments 78 to 90, wherein the second conductive layer has a uniform or variable thickness ranging from about 1 μm to about 400 μm, about 1 μm to about 350 μm, about 200 μm to about 350 μm, about 1 μm to about 50 μm, about 5 μm to about 50 μm, about 50 μm to 250 μm, or about 5 μm to about 200 μm.

Embodiment 92. The laminate of any one of embodiments 78 to 91, wherein the insulating layer has a uniform or variable thickness ranging from about 1 μm to about 400 μm, about 1 μm to about 350 μm, about 200 μm to about 350 μm, about 1 μm to about 50 μm, about 5 μm to about 50 μm, about 50 μm to 250 μm, or about 5 μm to about 200 μm.

Embodiment 93. An electrode case for a button or a coin cell battery comprising the laminate of any one of embodiments 78 to 92.

Embodiment 94. The electrode case of embodiment 93, wherein the electrode case is a cathode case.

Embodiment 95. A method of manufacturing a cathode case comprising: stamping the laminate of any one of embodiments 78 to 92 to form a cathode case comprising a bottom, an annular side, and a rim; and forming at least one bridge between the first and the second conductive layers, wherein the first conductive layer forms an interior surface of the case, and the second conductive layer forms an exterior surface of the case.

Embodiment 96. The method of embodiment 95, wherein the forming comprises crimping the rim, thereby forming the at least one bridge.

Embodiment 97. The method of embodiment 95, wherein the stamping forms the at least one bridge.

Embodiment 98. The method of embodiment 95, wherein forming the at least one bridge comprises soldering, vapor depositing, plating, brazening, printing with conductive ink, or otherwise affixing a bridge material to the first conductive layer and/or the second conductive layer.

Embodiment 99. The method of any one of embodiments 95 to 98, wherein the at least one bridge comprises a portion of the first conductive layer in electrical contact with the second conductive layer.

Embodiment 100. The method of any one of embodiments 93 to 99, wherein the at least one bridge comprises a portion of the second conductive layer in electrical contact with the first conductive layer.

Embodiment 101. The method of any one of embodiments 95 to 100, wherein the at least one bridge comprises a conductive wire, a conductive strip, or a conductive sheet.

Embodiment 102. The method of any one of embodiments 95 to 101, wherein a plurality of bridges is formed.

Embodiment 103. The method of any one of embodiments 95 to 101, wherein a single bridge is formed.

Embodiment 104. A method of manufacturing a cathode case comprising: a) providing a cup-shaped insulating layer having a rim, an interior surface, and an exterior surface; b) depositing a conductive film on the interior surface, the exterior surface, and the rim of the insulating layer to form an inner conductive layer and at least one bridge; c) placing the insulating layer with the conductive film into a cup-shaped outer conductive layer having a bottom, an annular side wall and a rim such that the inner and outer conductive layers are in electrical contact through the at least one bridge, thereby forming the cathode case.

Embodiment 105. The method of embodiment 104, wherein the insulating layer with the conductive film partially covers the rim of the outer conductive layer.

Embodiment 106. The method of embodiment 104, wherein the insulating layer with the conductive film completely covers the rim of the outer conductive layer.

Embodiment 107. A method for manufacturing a cathode case comprising: a) providing a cup-shaped insulating layer having a rim, an interior surface, and an exterior surface; b) depositing a conductive film on the interior surface of the insulating layer and folding the film over the rim of the insulating layer to form an inner conductive layer and at least one bridge; c) placing the insulating layer with the conductive film into a cup-shaped outer conductive layer having a bottom, an annular side wall and a rim such that the inner and outer conductive layers are in electrical contact through the at least one bridge, thereby forming the cathode case.

Embodiment 108. The method of embodiment 107, wherein rim of the insulating layer is extended, and the extended rim of the insulating layer covers the entire rim of the outer conductive layer.

Embodiment 109. The method of embodiment 108, wherein the rim of the insulating layer covers a part of the rim of the outer conductive layer.

Embodiment 110. A method for manufacturing a cathode case comprising: a) providing an inner conductive layer, an outer conductive layer, and an insulating layer; and b) assembling the inner conductive layer, the outer conductive layer, and the insulating layer, thereby forming the cathode case, wherein the inner conductive layer comprises an extended rim with an extension that drapes over the rim to contact the outer conductive layer, thereby forming at least one bridge.

Embodiment 111. The method of embodiment 110, wherein the insulating layer and the outer conductive layer are formed into a cup shape and the inner conductive layer is applied to the insulating layer and outer conductive layer to form the cathode case.

Embodiment 112. The method of any one of embodiments 104 to 111, wherein the insulating layer and/or inner conductive layer are formed into a cup-shape by thermoforming.

Embodiment 113. A method for forming a cathode case comprising: a) providing a laminate comprising a first conductive layer, a second conductive layer and an insulating layer between the first and second conductive layers; b) stamping the laminate into a cup shape have a bottom, an annular side wall, and a rim; and c) applying a conductive foil over the rim thereby forming at least one bridge between the inner conductive layer and the outer conductive layer.

Embodiment 114. A method of manufacturing a cathode case comprising: a) providing an internal support comprising a bottom, an annular side, a rim, an interior surface, and an exterior surface; b) depositing an insulating layer on the interior, the exterior and the rim of the internal support; c) depositing a first conductive material on the insulating layer on the interior surface and optionally the rim thereby forming an inner conductive layer; and d) depositing a second conductive material on the insulating layer on the exterior surface and optionally the rim thereby forming an outer conductive layer; wherein the inner conductive layer and the outer conductive layers are in electrical contact via at least one bridge.

Embodiment 115. A method for forming a cathode case comprising: a) preparing a cup-shaped insulating layer, the cup-shaped insulating layer comprising an interior, a rim, and an outer wall, b) coating the cup-shaped insulating layer with a conductive material to form a coated cup-shaped insulating layer, wherein the conductive material covers the interior, the rim, and up to about 50% of the top half of the outer wall, and c) placing the coated cup-shaped insulting layer into a cup-shaped outer conductive layer to form the cathode case.

Embodiment 116. The method of embodiment 115, wherein the cup-shaped insulating layer is prepared by thermoforming an insulating material.

Embodiment 117. The method of embodiment 115 or 116, wherein the conductive layer is coated onto the cup-shaped insulating layer using physical vapor deposition.

Embodiment 118. The method of any one of embodiments 115 to 117, wherein placing the coated cup-shaped insulating layer comprises press fitting, securing with an adhesive, or both.

Embodiment 119. A method of forming a cathode case comprising: a) providing a laminate comprising a conductive layer and an insulating layer, b) forming the laminate into a cup shape having an extended rim, b) folding the extended rim to form a continuous conductive layer from the inside of the cup to the outer wall of the cup, and c) placing the cup-shaped laminate into a cup-shaped outer conductive layer to form the cathode case.

Embodiment 120. A method of forming a cathode case comprising: a) providing a laminate comprising a conductive layer and an insulating layer, b) stamping the laminate to form a laminate cup having a plurality of tabs, c) folding the tabs towards the outside of the laminate cup, thereby forming an inner conductive layer and an insulating layer, and d) placing the cup with folded tabs into a cup-shaped outer conductive layer to form the cathode case.

Embodiment 121. The method of embodiment 120, wherein the cup-shaped outer conductive layer comprises a plurality of channels that align with the tabs on the cup-shaped laminate, and the plurality of tabs are folded into the channel.

Embodiment 122. The method of embodiment 121, further comprising completing an electrical connection between the inner and outer conductive layers by soldering or applying a conductive adhesive to the folded tabs and outer conductive layer.

Embodiment 123. A method of forming a cathode case, comprising: a) providing a conductive foil, b) stamping the conductive foil to form a cup-shaped foil having a plurality of tabs, c) folding the tabs toward the exterior of the cup-shaped foil, d) placing the inner conductive layer inside a cup comprising an insulting material such that the tabs are on the outside of the insulating cup, thereby forming an inner conductive layer and an insulating layer, and e) placing the inner conductive layer and insulating layer into a cup-shaped outer conductive layer, wherein the placing comprising press fitting, securing with an adhesive, or both.

Embodiment 124. The method of embodiment 123, wherein the cup-shaped outer conductive layer comprises a plurality of channels that align with the tabs on the cup-shaped foil, and the tabs are folded into the channel.

Embodiment 125. The method of embodiment 124, further comprising completing an electrical connection between the inner and outer conductive layers by soldering or applying a conductive adhesive to the folded tabs and the outer conductive layer.

Embodiment 126. The method of any one of embodiments 95 to 125, wherein the insulating layer comprises a polyetherimide, polyethylene terephthalate, polyvinylidene fluoride, or any combination thereof.

Embodiment 127. The method of any one of embodiments 95 to 126, wherein the inner conductive layer comprises aluminum, an aluminum alloy, or any combination thereof.

Embodiment 128. The method of any one of embodiments 95 to 127, wherein the outer conductive layer comprises stainless steel.

Embodiment 129. A cathode case manufactured by the method of any one of embodiments 95 to 128.

Embodiment 130. A battery comprising the cathode case of embodiment 129 wherein the first and second conductive layers or the inner and outer conductive layers are in electrical contact through the at least one bridge, and wherein after contact of the at least one bridge with a conductive aqueous medium, the electrical contact between the first and the second conductive layers or the inner and outer conductive layers is reduced or severed.

Embodiment 131. The battery of embodiment 1, wherein the battery comprises a configuration as shown in any one of FIGS. 2A, 2B, 3, 4, 5, 6A, 6B, 7A, 7B, 8A, 8B, 9A, 9B, 10A, 10B, 11A, 11B, 12A, 12B, 13A, 13B, 13C, 13D, 13E, 13F, 13G, 14, 15A, 15B, 15C, 15D, 15E, 15F, 16A, 16B, 16C, 16D, 17A, 17B, 18A, 18B, 19A, 19B, 19C, 19D, 20A, 20B, 21, 22A, 22B, 22C, 23A, 23B, 23C, 23D, 24C, 25A, 25B, 25C, 25D, 26A, 26B, 27A, 27B, 27C, 30C, 30D, 33A, 33B, 34A, 39A, 39B, 39C, 40A, 40B, or 47.

Additional objects and advantages will be set forth in part in the description which follows, and in part will be obvious from the description, or may be learned by practice.

It is to be understood that both the foregoing general description and the following detailed description are exemplary and explanatory only and are not restrictive of the claims.

The accompanying drawings, which are incorporated in and constitute a part of this specification, illustrate several embodiments and together with the description, serve to explain the principles described herein.

### BRIEF DESCRIPTION OF THE DRAWINGS

FIG. 1 is a chart from the National Poison Data System (NPDS) depicting the frequency and severity of battery ingestion (major and fatal outcomes).

FIGS. 2A and 2B are cross-sectional schematics of an exemplary coin or button cell-type battery in accordance with an embodiment of the disclosure before (FIG. 2A) and after (FIG. 2B) contact with a conductive aqueous medium.

FIG. 3 is a cross-sectional schematic depicting a method for discharging an exemplary battery of the present disclosure after it has been deactivated by contact with a conductive aqueous medium.

FIG. 4 is a cross-sectional schematic of a cathode case in accordance with an embodiment of the present disclosure.

FIG. 5 is a cross-sectional schematic of a section of a cathode case and a gasket in accordance with an embodiment of the present disclosure.

FIGS. 6A and 6B are cross-sectional schematics of a section of a cathode case in accordance with an embodiment of the present disclosure with a gasket before and after contact with a conductive aqueous medium illustrating partial dissolution of a bridge positioned at the rim of the cathode case.

FIGS. 7A and 7B are cross-sectional schematics of a section of a cathode case in accordance with an embodiment of the present disclosure and a gasket before and after contact with a conductive aqueous medium illustrating formation of an oxide on a bridge positioned at the rim of the cathode case.

FIGS. 8A and 8B are cross-sectional schematics of a section of a cathode case in accordance with an embodiment of the present disclosure before and after contact with a conductive aqueous medium illustrating complete dissolution of a bridge positioned at the annular wall of the cathode case.

FIGS. 9A and 9B are cross-sectional schematics of a section of a cathode case in accordance with an embodiment of the present disclosure before and after contact with a conductive aqueous medium illustrating formation of an oxide on a bridge positioned at the annular wall of the cathode case.

FIGS. 10A and 10B are cross-sectional schematics of a section of a cathode case in accordance with an embodiment of the present disclosure before and after contact with a conductive aqueous medium illustrating dissolution of a bridge positioned at the bottom of the cathode case.

FIGS. 11A and 11B are cross-sectional schematics of a section of a cathode case in accordance with an embodiment of the present disclosure before and after contact with a conductive aqueous medium illustrating formation of an oxide on a bridge positioned at the bottom of the cathode case.

FIGS. 12A and 12B are cross-sectional schematics of a section of a cathode case in accordance with an embodiment of the present disclosure in which a bridge is positioned through the gasket (FIG. 12A). In the embodiment, the bridge provides the electrical contact between the inner conductive layer and the outer conductive layer when the rim of the cathode case is crimped (FIG. 12B).

FIGS. 13A to 13G depict cross-sectional schematics of cathode cases having different thicknesses of the inner conductive layer, the outer conductive layer, and the insulating layer, in accordance with several embodiments of the present disclosure (the bridge is not depicted in FIGS. 13A-13E).

FIG. 14 is a cross-sectional schematic of an exemplary multi-layer laminate.

FIGS. 15A and 15B are schematics depicting an exemplary method of manufacturing a cathode case and FIGS. 15C, 15D, 15E, and 15F are close-up schematics depicting an exemplary method of manufacturing the rim of a cathode case.

FIGS. 16A and 16B are schematics depicting another exemplary method of manufacturing a cathode case.

FIGS. 16C and 16D are schematics depicting another exemplary method of manufacturing a cathode case.

FIGS. 17A and 17B are schematics depicting another exemplary method of manufacturing a cathode case.

FIGS. 18A and 18B are schematics depicting another exemplary method of manufacturing a cathode case.

FIGS. 19A and 19B are schematics depicting another exemplary method of manufacturing a cathode case.

FIGS. 19C and 19D are schematics depicting another exemplary method of manufacturing a cathode case.

FIGS. 20A and 20B are schematics depicting another exemplary method of manufacturing a cathode case.

FIG. 21 is a schematic depicting another exemplary method of manufacturing a cathode case.

FIG. 22A depicts an exemplary cup-shaped insert having a plurality of tabs, which is useful in manufacturing batteries of the present disclosure.

FIG. 22B is a schematic depicting another exemplary method of manufacturing a cathode case.

FIG. 22C is a schematic depicting another exemplary method of manufacturing a cathode case.

FIG. 23A is a schematic depicting another exemplary method of manufacturing a cathode case.

FIG. 23B is a schematic depicting another exemplary method of manufacturing a cathode case.

FIG. 23C is a schematic depicting another exemplary method of manufacturing a cathode case.

FIG. 23D is a schematic depicting another exemplary method of manufacturing a cathode case.

FIGS. 24A and 24B are photographs of a four probe milliohm meter (Extech Model #380580), which is useful for measuring the resistance of cathode cases of the present disclosure.

FIG. 24C is a schematic depicting the measurement of resistance of a cathode case of the present disclosure.

FIGS. 25A and 25B are photographs of an exemplary cathode case of the present disclosure.

FIG. 25C depicts a scanning electron microscope (SEM) image of a portion of the rim of the cathode case of FIG. 25B, and FIG. 25D depicts a schematic of the cathode case.

FIGS. 26A and 26B are top-down view SEM images of the rim of an exemplary cathode case.

FIGS. 27A to 27C depict an exemplary cathode case used in assembling an example CR2032 lithium battery. FIG. 27A is a schematic of a cathode case that has been crimped at the rim, FIG. 27B is a top down view SEM image of the crimp area of the assembled battery, and FIG. 27C is an X-ray tomography scan of the battery.

FIG. 28 is a graph showing the change in pH over a 3 hour period after a commercial control battery, a lab-made control battery, and an exemplary battery of the present disclosure were immersed in a 0.85% aqueous saline solution.

FIGS. 29A and 29B are photographic images of the results of a saline immersion test, in which a commercial control battery, a lab-made control battery, and an exemplary battery of the present disclosure immersed in the 0.85% saline solution at t=5 minutes (FIG. 29A) andt=60 minutes (FIG. 29B).

FIGS. 30A to 30D are top-down SEM images of the lab-made control and treatment batteries after the saline immersion test.

FIGS. 31A to 31C are graphs showing the change in voltage over a 2 hour period after a commercial control battery and several exemplary batteries of the present disclosure were immersed in a 25% Ringers solution.

FIG. 32 is a graph showing the change in voltage over a 10 day period after a commercial control battery and an exemplary battery of the present disclosure were immersed in 18 Mohm-cm deionized water.

FIGS. 33A and 33B are photographs of an exemplary cathode case of the present disclosure.

FIG. 34 shows photographs of an exemplary battery of the present disclosure and a commercial control battery, respectively.

FIGS. 35A and 35B are graphs showing the change in pH and voltage over a 2 hour period after a commercial control battery and several exemplary batteries of the present disclosure were immersed in a 25% Ringers solution.

FIGS. 36A and 36B show photographs of an exemplary battery of the present disclosure and a commercial control battery after 15 and 20 minutes respectively immersed in 25% Ringers solution.

FIGS. 37A and 37B show photographs of an exemplary battery of the present disclosure and a commercial control battery after 120 minutes immersed in 25% Ringers solution.

FIGS. 38A and 38B show photographs of an exemplary battery of the present disclosure and a commercial control battery after 14 and 17 days respectively immersed in 25% Ringers solution.

FIGS. 39A, 39B, and 39C show microscope photographs of the gasket area, the cathode side, and anode side respectively of an exemplary battery of the present disclosure after 14 days immersed in 25% Ringers solution, cleaned and dried.

FIGS. 39D, 39E, and 39F show microscope photographs of the gasket area, the cathode side, and anode side respectively of a commercial control battery after 17 days immersed in 25% Ringers solution, cleaned and dried.

FIG. 40A is a photograph of an exemplary crimped cathode case with an access hole for resistivity measurements and 40B is a schematic of the same.

FIG. 41 provides graphs showing resistance in milliohms of exemplary crimped cathode cases versus days exposed to 60° C. at four different humidity ranges.

FIG. 42 is a series of photographic images of porcine esophagus after exposure to a Maxell commercial control battery at different time points.

FIG. 43 is a series of photographic images of porcine esophagus after exposure to a lab-made control battery at different time points.

FIG. 44 is a series of photographic images of porcine esophagus after exposure to an exemplary battery of the present disclosure at different time points.

FIG. 45 is a graph showing the change in pH over a one-hour period after a Maxell commercial control battery, a lab-made control battery, and an exemplary battery of the present disclosure were wrapped in ham hydrated with a 0.85% aqueous saline solution.

FIGS. 46A, 46B, and 46C are photographic images of ham after exposure to a Maxell commercial control battery, a lab-made control battery, and an exemplary battery after 60 minutes.

FIG. 47 is an image of an exemplary CR2032 battery manufactured in accordance with the present disclosure.

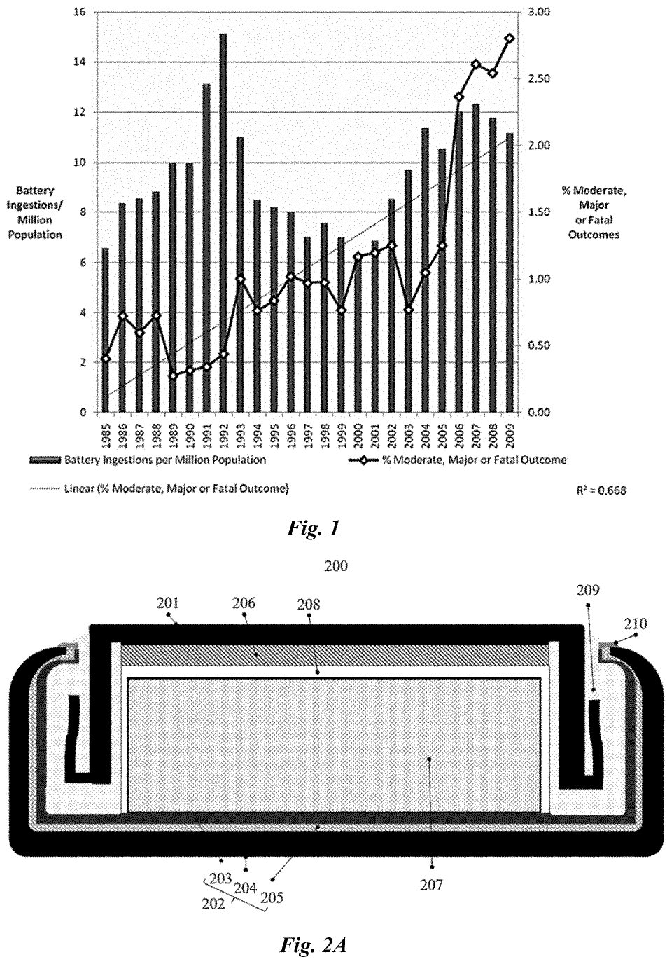

### DESCRIPTION OF CERTAIN EMBODIMENTS

As used herein, the term about refers to a numeric value, including, for example, whole numbers, fractions, and percentages, whether or not explicitly indicated. The term about generally refers to a range of numerical values (e.g., +/−5-10% of the recited range) that one of ordinary skill in the art would consider equivalent to the recited value (e.g., having the same function or result). When terms such as at least and about precede a list of numerical values or ranges, the terms modify all of the values or ranges provided in the list. In some instances, the term about may include numerical values that are rounded to the nearest significant figure.

As used here, “a” or “an” means “at least one” or “one or more” unless otherwise specified. As used herein, the term “or” means “and/or” unless specified otherwise. In the context of a multiple depending claim, the use of “or” when referring back to other claims refers to those claims in the alternative only.

### I. Exemplary Batteries

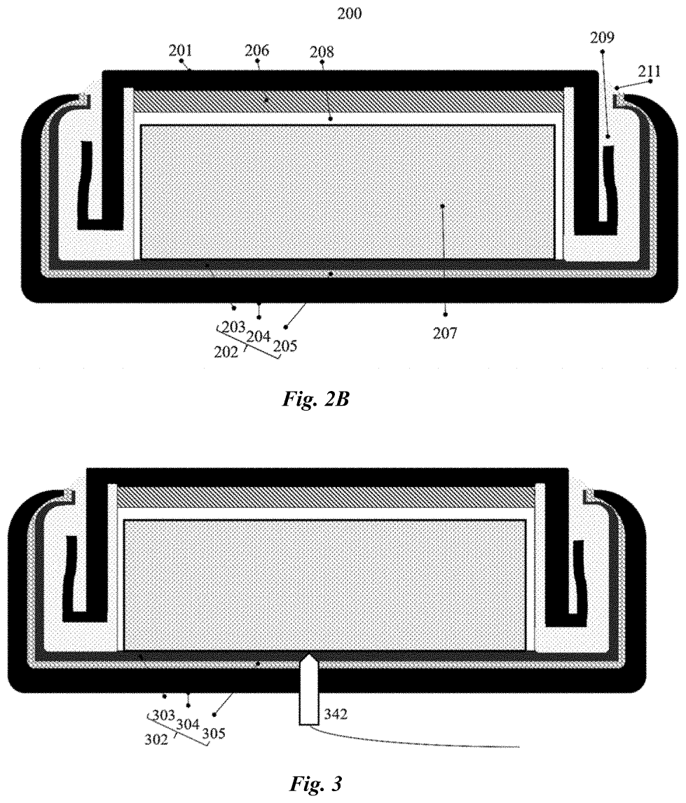

The present disclosure provides batteries that are safer and less likely to damage tissue when ingested, for example when a child or pet accidentally swallows the battery. The present disclosure pertains to any battery, and in particular embodiments, the present disclosure provides a coin or button cell-type battery, such as a 3 volt or a 1.5 volt button cell battery. FIG. 2A depicts a cross sectional view of an exemplary coin or button cell-type battery 200 in accordance with one embodiment of the disclosure.

Exemplary battery 200 comprises:

an anode case 201;

a cathode case 202, the cathode case comprising an inner conductive layer 203, an outer conductive layer 204, and an insulating layer 205 between the inner and the outer conductive layers,

an electrochemical cell comprising an anode 206, a cathode 207, and a separator 208 between the anode and the cathode; and

a gasket 209 between the anode case and the cathode case;

wherein the inner and the outer conductive layers are in electrical contact through at least one bridge 210.

In some embodiments, after contact of the at least one bridge with a conductive aqueous medium, the electrical contact between the inner conductive layer and the outer conductive layer through the at least one bridge is reduced or severed.

FIG. 2B depicts an embodiment of battery 200 in which the bridge has undergone at least partial electrochemical dissolution due to contact with a conductive aqueous medium. In this embodiment, the bridge is no longer present, and the insulating layer 205, the gasket 209, or both have filled in space where the bridge once was 211. Thus, inner conductive layer 203 and outer conductive layer 204 no longer have electrical contact with each other.

While not being bound by theory, the present batteries are safer upon accidental ingestion because the current flow between the anode and cathode is interrupted in a relatively short period of time, thereby preventing the formation of a caustic local environment around the battery that can cause tissue damage. When at least one bridge and the anode case are in contact with a conductive aqueous medium, a transient conductive pathway can form between the anode and cathode, thereby allowing current to flow. In the presence of this current, the bridge undergoes electrochemical oxidation. Electrochemical oxidation of the bridge reduces its conductivity or severs it thereby reducing or severing the electrical connection between the inner and outer conductive layers, effectively limiting the conductive pathway and the resulting current over a relatively short period of time, such as within two hours, one hour, 30 minutes, 20 minutes, 10 minutes or 5 minutes.

In one embodiment, oxidation of a bridge results in electrochemical dissolution of the bridge material, such as dissolution of metal ions into the conductive aqueous medium. In another embodiment, oxidation of the bridge results in formation of an oxide on the bridge. The oxide effectively insulates the bridge such that the electrical connection is reduced.

After the battery has been exposed to a conductive aqueous solution and the bridge has been oxidized to deactivate the battery, the battery cannot be easily discharged to exhaust the energy in the cell by conventional means. As depicted in FIG. 3, to discharge the battery, a sharp conductive probe 342 can puncture the bottom of the cathode case and pass through the outer conductive layer 304 and insulating layer 305 to make electrical contact with the inner conductive layer 303. This will allow the battery to be discharged by conventional means.

The term “bridge” as used herein refers to a connection or link between inner and outer conductive layers that are separated by an insulating layer. The bridge provides an electrical contact between the inner and outer conductive layers. The bridge may comprise a conductive material that is the same as or different from the inner and/or outer conductive layer materials. In certain embodiments, the bridge comprises at least one extension of the inner conductive layer and/or the outer conductive layer. The extension may be one or more projections extending radially outward from a conductive layer, or the extension may be a single annular ring. In other embodiments, the bridge may comprise a wire, strip, or sheet of a conductive material that is soldered or otherwise affixed to the inner and outer conductive layers such that the electric connection is established. In some embodiments, the at least one bridge comprises a material that is capable of electrochemical oxidation when at least one part of the bridge is exposed to a conductive aqueous medium. For example, the at least one bridge comprises a material that is capable of electrochemical oxidation when a transient conductive pathway is formed between the anode and the cathode through a conductive aqueous medium.

The “electrical contact” provided by a bridge has a low resistance such that a current can flow. In one embodiment, the electrical contact may be measured by determining the electrical resistance between the inner and the outer conductive layers. In one embodiment, the electrical resistance between the inner and the outer conductive layers is less than about 1 ohm, from about 0.01 ohms to about 1 ohm, from about 1 ohm to about 10 ohms, or from about 10 ohms to about 100 ohms prior to the contact with a conductive aqueous medium. In another embodiment, the electrical contact is measured by determining the electrical conductivity between the inner and the outer conductive layers through the at least one bridge in a dry environment, for example, prior to contact with a conductive aqueous medium. Electrical conductivity can be determined by measuring the resistance, current, and/or voltage.

In some embodiments, electrical contact comprises an inner conductive layer, a bridge, and an outer conductive layer in physical contact through coating, pressing, crimping, stamping, pinching, soldering, welding, and/or the use of adhesives. In other embodiments, electrical contact comprises at least two conductive surfaces in close proximity allowing for quantum tunneling between the inner conductive layer and the bridge, between the bridge and outer conductive layer, or between the inner conductive layer and the bridge in addition to the bridge and outer conductive layer. In another embodiment, a quantum tunneling composite is used to make electrical contact.

The electrical contact is reduced or severed after contact with a conductive aqueous medium within a relatively short period of time. Once the electrical contact is reduced or severed, the current flow is such that the formation of hydroxide ions is greatly reduced or ceases, and a high pH, caustic environment is not formed. The reduction or severance of the electrical contact may be determined by measuring the resistance, the current, and/or the battery voltage. In some embodiments, the electrical contact is reduced or severed within about 60 minutes or less, about 30 minutes or less, about 20 minutes or less, or about 10 minutes or less. Because the electrical contact is reduced relatively quickly, the damage caused in vivo may be significantly reduced.

In some embodiments, the resistance between the inner and outer conductive layers increases to greater than about 500 ohms, greater than about 50 kohms, or greater than about 500 kohms after contact with a conductive aqueous medium. In other embodiments, the resistance increases such that the voltage of the battery, after drying, is 1.23 V or less.

The battery is considered dry when the battery is removed from and is no longer in contact with an aqueous medium (conductive or non-conductive) for at least about 24 hours and is, for example, placed in a desiccator during those 24 hours.

Open circuit voltage (OCV) is the difference of electrical potential between two terminals of a device when disconnected from any circuit, also known as an open circuit. Closed circuit voltage (CCV) is the difference of electrical potential between two terminals of a device when connected in a circuit. CCV measurements may also be indicated by specifying the resistor used in series in the circuit along with the duration of time. Examples of some CCV measurements disclosed herein use about a 15 kohm resistor, about a 3.9 kohm resistor, or about a 1 kohm resistor. Examples of time durations used to measure CCV disclosed herein are about 1 sec, about 3 sec, or about 5 sec after closing the circuit. The measurement of OCV and CCV of the battery are known in the art.

In some embodiments, after the contact with a conductive aqueous environment, the OCV of the exemplary battery is less than about 1.23 V, is less than about 1.2 V, or is less than about 1 V after about a 5 second measurement.

In further embodiments, after the contact with a conductive aqueous environment, the CCV of the exemplary battery is less than about 1.23 V, is less than about 1.2 V, or is less than about 1 V after about a 1 second to about a 5 second measurement when in series with about a 15 kohm resistor, about a 3.9 kohm resistor, or about a 1 kohm resistor.

In other embodiments, after the contact with a conductive aqueous environment, the current between the inner conductive layer and the outer conductive layer is less than about 0.1 mA, less than about 0.01 mA, or less than about 1 ρA.

“Reduced” means a reduction relative to a reference. In some embodiments, by “reduced” is meant the reduction of about 5% or more, of about 10% or more, of about 20% or more, of about 30% or more, of about 40% or more, of about 50% or more, of about 60% or more, of about 70% or more, of about 80% or more, of about 90% or more, of about 100% or more, of about 200% or more, of about 500% or more, or of about 1000% or more relative to a reference value. In some embodiments, by “reduced” is meant the reduction of about 5% to about 50%, of about 10% to about 20%, of about 50% to about 100%. In some embodiments, the reduction may be in reference to the electrical contact, current, or voltage of the battery prior to contact with a conductive aqueous medium.

“Electrical contact is severed” means the electrical connection between two components is broken and the electrical circuit is an open circuit.

“Increased” means an increase relative to a reference. In some embodiments, by “increased” is meant an increase of about 5% or more, of about 10% or more, of about 20% or more, of about 30% a or more, of about 40% or more, of about 50% or more, of about 60% or more, of about 70% or more, of about 80% or more, of about 90% or more, of about 100% or more, of about 200% or more, of about 1000% or more, of about 10,000%, and/or of about 100,000% relative to a reference value. In some embodiments, by “increased” is meant an increase of about 5% to about 100%, of about 100% to about 10,000%, of about 10,000% to about 1,000,000%. In some embodiments, the increase may be in reference to the resistance between the inner and outer conductive layers prior to the contact with the conductive aqueous medium.

Several embodiments of the bridge are possible. For example, a bridge may be formed from an extension or protrusion of the inner conductive layer such that the bridge is in electrical contact (e.g., in physical contact) with the outer conductive layer. Alternatively, a bridge may comprise a portion of the outer conductive layer such that the bridge is in electrical contact (e.g., in physical contact) with the inner conductive layer.

The bridge may comprise a material that is the same as or different from the inner and outer conductive layers. In certain embodiments, the bridge comprises a material that oxidizes more rapidly than the inner or outer conductive layers. The oxidation rate of the bridge will depend on the specific material, the texture of the material, and/or the thickness of the material used to form the bridge.

In some embodiments, the at least one bridge comprises a plurality of extensions, each extension comprising:

a) a portion of the inner conductive layer extending over the insulating layer to electrically contact the outer conductive layer along the rim of the cathode case, or

b) a portion of the outer conductive layer extending over the insulating layer to electrically contact the inner conductive layer along the rim of the cathode case, or

c) a combination of a) and b).

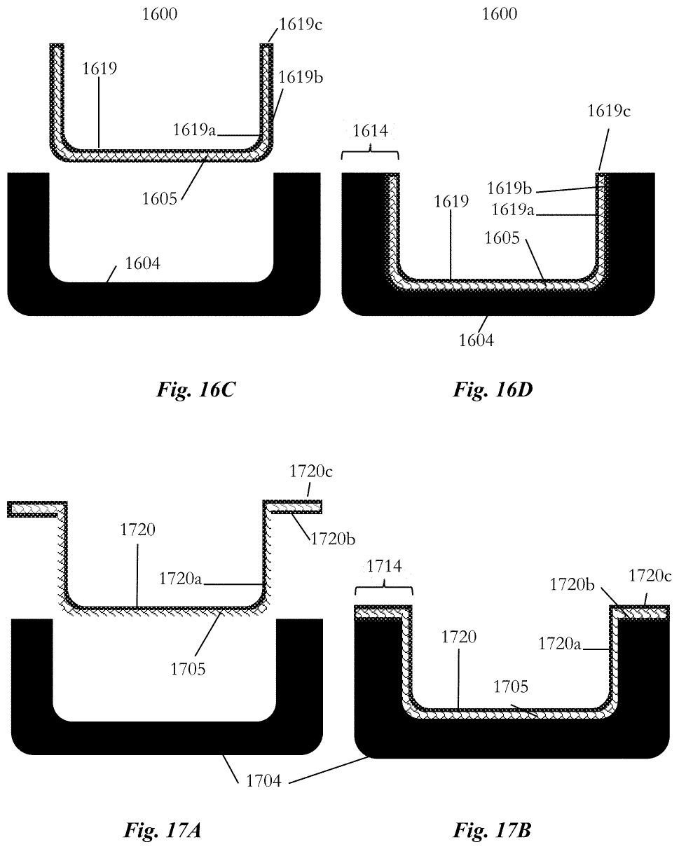

FIG. 16B depicts an exemplary cathode 1600 case having a bridge comprising a plurality of extensions 1619c of the inner conductive layer 1619 in contact with the outer conductive layer 1604 at multiple points 1614 along the rim of the cathode case.

In certain embodiments, the at least one bridge comprises at least one seam along the rim of the cathode case, the at least one seam comprising:

a) the inner conductive layer extending over the insulating layer to electrically contact the outer conductive layer at the rim of the cathode case, or

b) the outer conductive layer extending over the insulating layer to electrically contact the inner conductive layer at the rim of the cathode case, or

c) a combination of a) and b).

The seam can be created through crimping, stamping, pinching, soldering, welding, and/or adhesives. FIG. 26B is an example of a seam created through ultrasonic welding. A seam can range from a short distance, for example 10 μm, to a continuous or semi-continuous seam along the circumference of the rim.

A “conductive aqueous medium” as used herein includes without limitation conductive water-containing solutions, such as aqueous salt solutions and aqueous buffered solutions; bodily fluids, such as digestive fluids, saliva, mucous, wet tissue, and blood; aqueous gels; and the like. The resistivity of a conductive aqueous medium is 1 Mohm-cm or less.

A “non-conductive aqueous medium” as used here in refers to purified or deionized water or to solutions of water including nonionic cleaning detergents where the solution has a resistivity of more than 1 Mohm-cm.

A “conductive pathway” as used herein includes without limitation a path where charge can flow to complete a circuit between the anode and cathode of a battery. The anode case and the bridge, for example, form a conductive pathway when both are in contact with a conductive aqueous medium. Electrolysis of water is one indicator of the presence of a conductive pathway. One indicator of electrolysis may be the presence of bubbling from the anode when the battery is in contact with the conductive aqueous medium. Alternatively, an increase in pH near the anode terminal may indicate the presence of a conductive pathway.

Anode and cathode materials can be chosen from any known in the battery art. The anode case provides a protective barrier for the anode, and generally comprises a conductive material. Suitable materials for the anode case are known to those in the art. The separator generally provides physical separation between the anode and the cathode and can be made from any materials known in the art. Additionally, an electrolyte may be included in the battery, as well understood in the art.

A gasket is advantageously between the anode case and the cathode case and may provide a seal between the anode and cathode. The gasket may comprise a non-conductive material, such as an elastomeric material or a plastic. Non-conductive materials include, without limitation, nylon, polytetrafluoroethylene, fluorinated ethylene-propylene, chlorotrifluoroethylene, perfluoroalkoxy polymer, polyvinyls, polyethylene, polyethylene terephthalate, polypropylene, polystyrene, polysulfone, silicone rubbers, and the like.

### II. Exemplary Cathode Case

A. Exemplary Cathode Case Structure

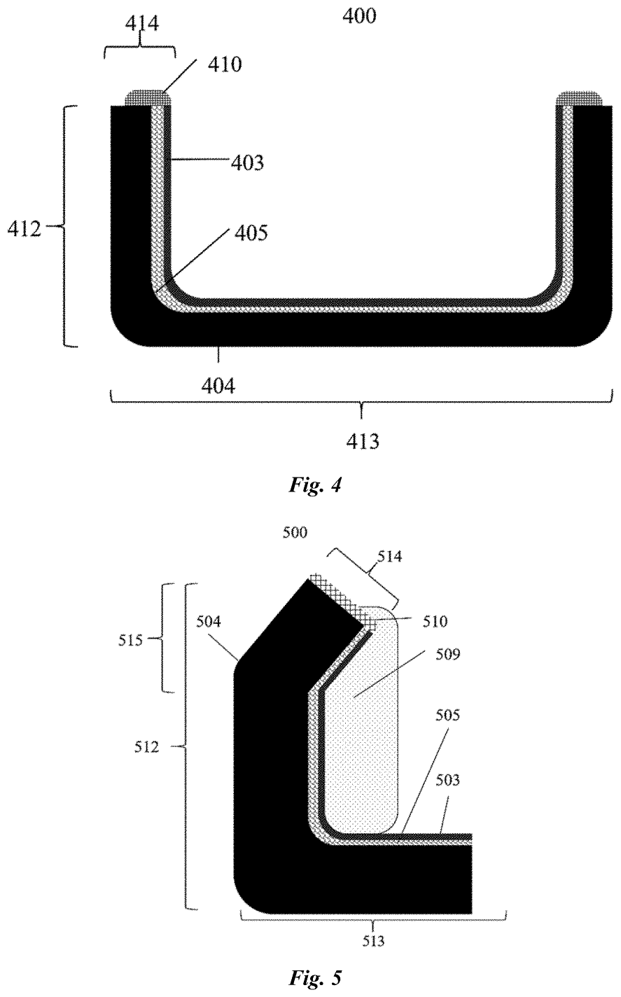

FIG. 4 depicts an exemplary cathode case useful in the battery of the present disclosure. Cathode case 400 comprises a bottom 413, an annular side 412, and a rim 414. The case comprises inner conductive layer 403, outer conductive layer 404, insulating layer 405, and bridge 410, which in this embodiment, is positioned at the rim 414. In other embodiments, the bridge may be positioned at the bottom or the annular side of the cathode case. In yet another embodiment, the bridge may be at any combination of the rim, the annular side or the bottom of the cathode case.

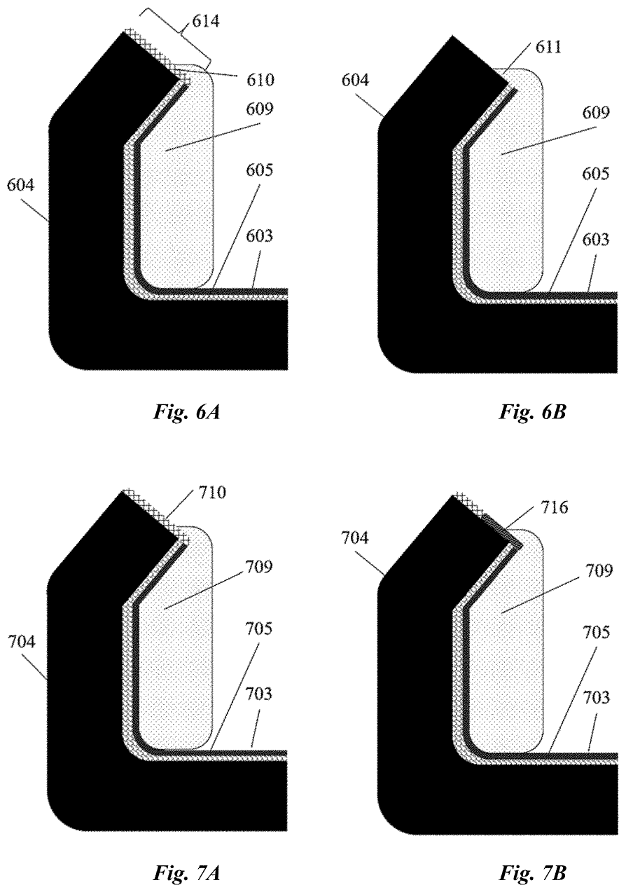

FIG. 5 depicts an expanded cross-sectional schematic of a section of a cathode case 500 according to one embodiment having a bottom 513, annular side 512 and rim 514. Gasket 509 is also depicted. In this embodiment, part of the annular side is crimped to form a crimp area 515 that includes the rim 514. The case comprises inner conductive layer 503, outer conductive layer 504, insulating layer 505, and bridge 510, which in this embodiment, is positioned at the rim 514. In some embodiments, for example, as depicted in FIGS. 6A and 7A, the bridge is formed in the crimp area (615, 715) during the crimping process.

As seen in FIG. 6A, the bridge 610 may be positioned at the rim 614 of the cathode case. The case comprises inner conductive layer 603, outer conductive layer 604, insulating layer 605, and bridge 610, which in this embodiment, is positioned at the rim 614. Gasket 609 is also depicted. As discussed above, the electrical contact between the inner and outer layers is severed or reduced by oxidation of the bridge due to the conductive pathway formed between the anode and cathode in a conductive aqueous medium. In one embodiment, the oxidation results in electrochemical dissolution of some or all of the bridge. FIG. 6B depicts a change in the bridge after exposure to a conductive aqueous medium according to one embodiment. Bridge 610 is intact prior to contact with the conductive aqueous medium as seen in FIG. 6A, while after exposure, at least part of the bridge has dissolved 611. In this embodiment, gasket 609 has expanded to cover the inner conductive layer, thereby reducing the electrical contact between the inner conductive layer 603 and outer conductive layer 604.

FIGS. 7A and 7B depict an alternative embodiment in which the bridge material forms an oxide 716 after contact with a conductive aqueous medium, and the gasket 709 continues to cover the inner conductive layer and reduce contact with the conductive aqueous solution. The oxide thus severs or reduces the electrical contact between the inner and outer conductive layers. The case comprises inner conductive layer 703, outer conductive layer 704, insulating layer 705, and bridge 710.

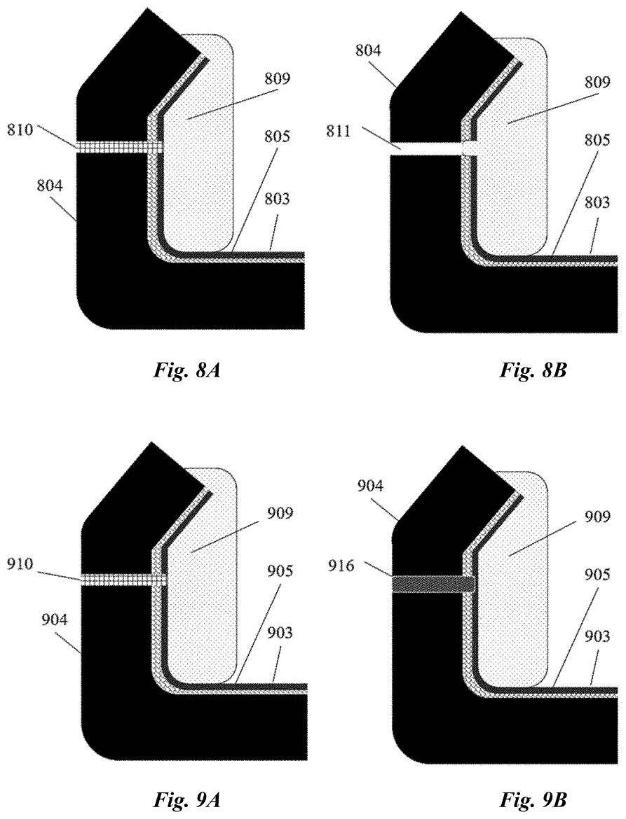

FIGS. 8A to 9B are schematics of exemplary cathode cases in which the bridge is positioned at the annular side of the cathode case. In these embodiments, bridges 810 and 910 oxidize in the presence of a conductive aqueous medium to either dissolve (FIG. 8B, 811) or form an oxide (FIG. 9B, 916). The case comprises inner conductive layer 803 and 903, outer conductive layer 804 and 904, insulating layer 805 and 905, and bridge 810 and 910 respectively. Gasket 809 and 909 are also depicted.

In yet another embodiment, depicted in FIGS. 10A to 10B, the bridge 1010 is at the bottom of the cathode case to form an electrical contact between the inner 1003 and outer conductive layer 1004 through the insulating layer 1005 of the cathode case and the bridge. Gasket 1009 is also depicted. In the presence of a conductive aqueous medium, the bridge electrochemically dissolves 1011 and the insulating layer 1005 expands to form a physical barrier between the inner conductive layer 1003 and the conductive aqueous medium breaking the conductive pathway (FIG. 10B).

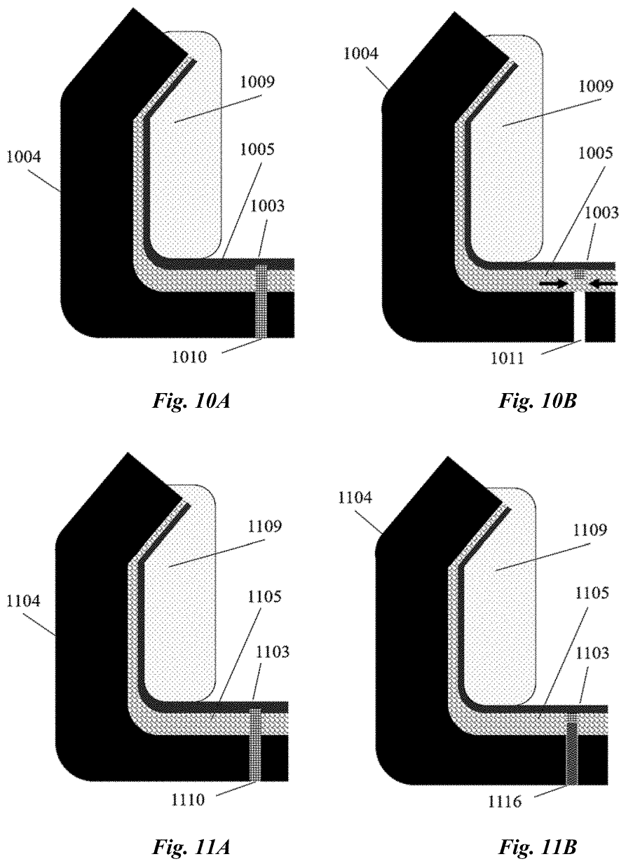

In another embodiment, depicted in FIGS. 11A to 11B, the bridge 1110 is at the bottom of the cathode case to form an electrical contact between the inner conductive layer 1103 and outer conductive layer 1104 through the insulating layer 1105 of the cathode case and the bridge. Gasket 1109 is also depicted. In the presence of a conductive aqueous medium, the bridge forms an oxide 1116 (FIG. 11B).

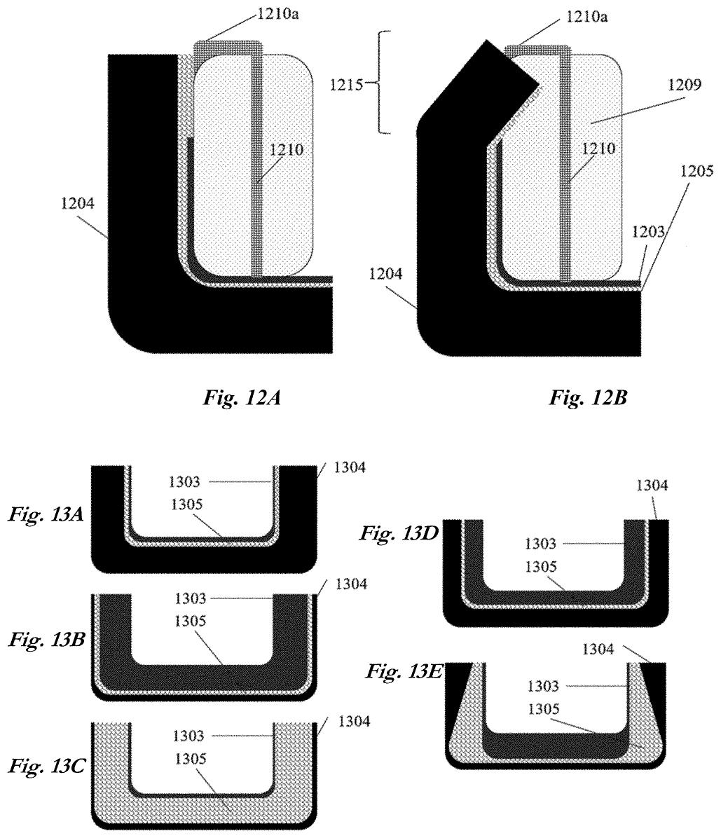

In another embodiment, depicted in FIGS. 12A and 12B, a bridge 1210 is positioned through the gasket 1209 from the inner conductive layer 1203 to the outer conductive layer 1204. The insulating layer 1205 may comprise any insulating polymer described in the other embodiments. The portion of the bridge that protrudes out of the top of the gasket 1210a forms the electrical connection between the inner conductive layer and the outer conductive layer after the rim has been crimped 1215. In some embodiments, the bridge from the inner conductive layer 1203 to the outer conductive layer 1204 may be made by any of the conductive bridge materials described herein and may be in any shape suitable to form the bridge and the electrical connection between the inner conductive layer and the outer conductive layer, such as a sheet, tab, thread, or rod. The sheet or tab may have a uniform or varying thickness ranging from about 100 nm to about 100 μm. The thread or rod may have a uniform or varying diameter ranging from about 50 nm to about 100 μm. In some embodiments the bridge is a wire. In alternative embodiments the bridge may be one or more layers or coatings formed between the inner conductive layer 1203 to the outer conductive layer 1204.

A bridge may be formed in any manner available to those skilled in the art, in addition to the crimping process described above. For example, the bridge can be stamped, ultrasonically welded, laser welded, sputtered, physical vapor deposited, plated, soldered, brazened, thermoformed, printed with conductive ink or otherwise affixed to the inner conductive layer and/or the outer conductive layer.

In still further embodiments, the insulating layer in the cathode case further comprises: a) a multilayered construction comprising an adhesive layer in contact with the outer conductive layer, b) a multilayered construction comprising an adhesive layer in contact with the inner conductive layer, or c) both a) and b).

An adhesive useful in this embodiment includes, without limitation, a pressure-sensitive adhesive, a rubber-based adhesive, an epoxy, a polyurethane, a silicone adhesive, a phenolic resin, a UV curable adhesive, an acrylate adhesive, or any combination of two or more thereof.

B. Exemplary Cathode Case Materials

The cathode case components may comprise a variety of materials known to those in the art. Suitable materials for the inner conductive layer include, without limitation, conductive metals. In certain embodiments, the inner conductive layer comprises aluminum, stainless steel, chromium, tungsten, gold, vanadium, nickel, titanium, tantalum, silver, an alloy thereof, or a combination of any two or more thereof. In a particular embodiment, the inner conductive layer comprises aluminum or an aluminum alloy.

The outer conductive layer also may comprise a conductive metal. Exemplary metals useful for the outer conductive layer include, without limitation, stainless steel, nickel, gold, aluminum, titanium, an alloy thereof, or a combination of any two or more thereof. In a particular embodiment, the outer conductive layer comprises stainless steel.

Stainless steel is an alloy and is commercially available in a variety of forms. Stainless steel useful for the outer conductive layer includes, without limitation, SS304, SS316, SS430, duplex 2205, duplex 2304, duplex 2507, or one or more other stainless steels with a chromium content equal to or greater than 10% by weight and/or a nickel content equal to or greater than 0.1%. by weight.

In addition to conductive metals, the inner conductive layer and outer conductive layer may comprise conductive composites. In one embodiment, conductive particles are embedded in a non-conductive medium to form an overall conductive film that is coated onto the cathode case as the inner conductive layer and/or the outer conductive layer. In another embodiment, conductive carbon black, carbon nanotubes, graphene, graphite, and/or carbon fibers are used as the conductive particles in a conductive composite film.

The insulating layer can be any insulating material known in the art. In some embodiments, the insulating layer has a breakdown voltage that is greater than the open circuit voltage of the battery.

The “breakdown voltage,” as used herein, is the minimum voltage that causes a portion of an insulator to become electrically conductive. In certain embodiments, the breakdown voltage of the insulating layer is greater than 3.3 volts. Useful materials for the insulating layer include, without limitation, a hydrophobic polymer, a natural rubber, a cellulose acetate, a paper dielectric, a ceramic, a metal oxide, a nitride, a carbide, or a combination of any two or more thereof.

A hydrophobic polymer includes, without limitation, a polyethylene terephthalate, a polytetrafluoroethylene, a fluorinated ethylene propylene, a perfluoroalkoxyalkane, a polyvinyl fluoride, a polyvinylidine difluoride, a polypropylene, a polyurethane, a polyimide, a dimethylpolysiloxane, or a combination of any two or more thereof. In some embodiments, the insulating layer comprises polyethylene terephthalate.

Metal oxides useful for the insulating layer include, without limitation, silicon dioxide, aluminum oxide, nickel oxide, chromium oxide, or a combination of any two or more thereof.

In one embodiment, the insulating layer comprises a cup-shaped thermoform. A cup-shaped thermoform may comprise a thermoplastic, including without limitation polyphenylene sulfide and/or a fluoropolymer (including polyvinylidene difluoride, polytetrafluoroethylene, perfluoroalkoxyalkane polymer, fluorinated ethylene propylene, and any combination thereof).

In another embodiment, the cup-shaped thermoform comprises a thermoplastic elastomer, including without limitation, a thermoplastic polyurethane, a thermoplastic polyolefin, or a combination thereof. In one embodiment, a thermoplastic elastomer comprises a copolymer, such as styrene-ethylene-butylene-styrene.

In some embodiments, the insulating layer comprises a multi-layered construct. For example, a multilayered construct may comprise an adhesive layer in contact with the outer conductive layer, an adhesive layer in contact with the inner conductive layer, or both.

An adhesive useful for the adhesive layer includes, without limitation, a pressure sensitive adhesive, a rubber-based adhesive, an epoxy, a polyurethane, a silicone adhesive, a phenolic resin, a UV curable adhesive, an acrylate adhesive, a laminating adhesive and derivatives thereof, a fluoropolymer, or any combination of two or more thereof. In certain embodiments, the adhesive comprises a low or high density polyethylene (HDPE/LDPE), a polyolefin or derivative thereof, an acid containing an adhesive such as EAA or EMAA, an ionomer, a terpolymer of ethylene, and acrylate, including methyl acrylate or isobutyl acrylate, ethylene-vinyl acetate (EVA), or any combination of two or more thereof.

In one embodiment, the insulating layer comprises a multilayer construct comprising an acrylic pressure sensitive adhesive layer in contact with the outer conductive layer, a laminating adhesive in contact with the inner conductive layer and a polyethylene terephthalate between the adhesive layers. In one embodiment, the insulating layer is multi-layered construct comprising a 25-40 μm layer of acrylic pressure sensitive adhesive in contact with the outer conductive layer, a 1-12.5 μm layer of laminate adhesive in contact with the inner conductive layer, and a 1-25 μm layer of polyethylene terephthalate between the two adhesive layers.

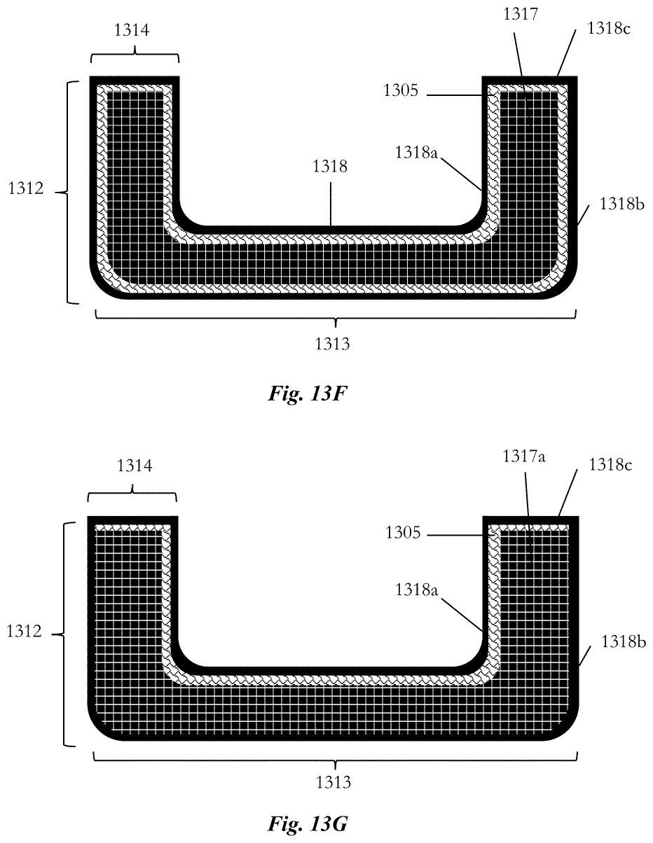

In some embodiments, the insulating layer further comprises an internal support member (FIG. 13F, 1317) covered with any of the aforementioned insulating materials. The internal support member, in some embodiments, comprises a commercially available cathode case, a metal, a polymer, or other layered or multilayered combinations and derivatives thereof.

In some embodiments, the internal support member comprises a metal, including, without limitation, stainless steel, nickel, gold, aluminum, titanium, an alloy thereof, or a combination of any two or more thereof. In one embodiment, the stainless steel used in the internal support member comprises SS304, SS316, SS430, duplex 2205, duplex 2304, duplex 2507, or one or more other steel with a chromium content equal to or greater than about 10% by weight and/or a nickel content equal to or greater than 0.1%. by weight.

In some embodiments, the internal support member is coated with an insulating layer. The insulating layer may cover part or all of the internal support member. In some embodiments, the insulating layer encapsulates the internal support member. In some embodiments, the coating comprises a thermoset elastomer. In some embodiments, a coating of up to about 50 μm of thermoset elastomer is spray-coated on an internal support member using an air assisted spray or needle dispensed conformal coating. Examples of thermoset elastomers include without limitation polydimethylsiloxane, crosslinked polyurethane coating, crosslinked acrylates, rubberized epoxy, or any combination thereof. Crosslinked acrylates may be crosslinked, in some embodiments, using an ultraviolet light source.

After coating, molding or thermoforming to form the insulating layer, the overall shrinkage of the insulating material, in some embodiments, is less than about 30%, less than about 15%, or less than about 5%.

After coating, molding or thermoforming to form the insulating layer, its dielectric properties can be determined by any conventional method, including by DC resistance or conductance. ASTM D257-14, Standard Test Methods for DC Resistance or Conductance of Insulating Materials, ASTM International, West Conshohocken, Pa., 2014, which is hereby incorporated by reference in its entirety, is one method of determining DC resistance or conductance of a material. In one embodiment, the insulating layer comprises a dielectric breakdown strength of at least 50V per 25 micron of insulating layer thickness.

In some embodiments, the glass transition temperature (Tg) of a polymer coating is sufficiently high in order to minimize warping, shrinkage, or deformation of the polymer during of a high temperature process, for instance during metallization. Alternatively, during test processes, the test battery may be exposed to temperatures of up to 130° C. for thermal abuse testing to confirm that the polymer layer does not shift in position or breakdown. The Tg of thermoplastic elastomers in some embodiments is greater than 80° C., greater than about 90° C., greater than about 100° C., greater than about 110° C., greater than about 120° C., greater than about 130° C., greater than about 140° C., or greater than about 150° C. In other embodiments, the glass transition temperature ranges from about 80° C. to about 350° C., about 80° C. to about 300° C., about 80° C. to about 250° C., about 90° C. to about 350° C., about 90° C. to about 300° C., about 90° C. to about 250° C., about 100° C. to about 350° C., about 100° C. to about 300° C., about 100° C. to about 250° C., about 110° C. to about 350° C., about 110° C. to about 300° C., about 110° C. to about 250° C., about 130° C. to about 350° C., about 130° C. to about 300° C., about 130° C. to about 250° C., about 140° C. to about 350° C., about 140° C. to about 300° C., about 140° C. to about 250° C., about 150° C. to about 350° C., about 150° C. to about 300° C., or about 150° C. to about 250° C.

In some embodiments, the decomposition temperature of the thermoset polymer is greater than about 85° C., greater than about 100° C., greater than about 125° C., greater than about 150° C., greater than about 175° C., or greater than about 200° C.

Another test that batteries may be subjected to is low to high thermal cycling from about −45° C. to about 75° C. In some embodiments, the insulating layer comprises a polymer that prevents cracking and internal shorting during thermal cycling.

In some embodiments, under immersion in water, 0.85% saline, 25% Ringers solution, or artificial saliva solution, the polymer may become saturated with water. Thus, there may be some diffusion of water through the polymeric insulating layer, resulting in a change in electrical properties of the insulating layer, referred to as “water permeability.” Water permeability may occur at the region around the crimp radius of a battery. The extent to which a polymer is exposed to water in this region may range from a 0 to 500 micron wide circumference around the inner diameter of a cathode can. The water permeability will therefore depend on the width of exposure to water and the type of polymer. Under immersion in water, 0.85% saline, or artificial saliva solution, the polymer may become saturated with water, resulting in water diffusion and an increase in conductivity of the insulating layer. In some embodiments, the increase in conductivity may be no more than about 1000%, no more than about 100%, or no more than about 10%.

Water permeability data on exemplary materials used in the Examples is provided in Table 1.

TABLE 1
Water permeability of exemplary insulating layer materials

| Polymer Type | | | ULTEM | | |
|---|---|---|---|---|---|
| D570 Data | Polypropylene | PET | PEI | PPS | PVDF |
| 24 Hours | 0.01 to | 0.1% | 0.25% | 0.02 to | 0.03 to |
| | 0.030% | | | 0.03% | 0.06% |
| Saturation | 0.1% | 0.7% | 1.25% | 0.05% | 0.06% |
| (Equilibrium) | | | | | |

The extent to which polymers absorbed water was measured according to ASTM standard testing, ASTM D570-98(2018), Standard Test Method for Water Absorption of Plastics, ASTM International, West Conshohocken, Pa., 2018, which is hereby incorporated by reference in its entirety.

In some embodiments, the bridge comprises a conductive material, such as a metal. Metals useful for the bridge material include metals that are readily oxidized in the presence of a current flow, such as stainless steel, magnesium, aluminum, manganese, zinc, chromium, cobalt, nickel, tin, antimony, bismuth, copper, silicon, silver, zirconium, or a combination of any two or more thereof. In some embodiments, the stainless steel comprises SS304, SS316, SS430, a duplex stainless steel, or one or more other steel with a chromium content equal to or greater than 10% by weight and/or a nickel content equal to or greater than 0.1% by weight.

In certain embodiments, the bridge oxidizes at the same rate or more rapidly than the outer conductive layer. In particular embodiments, the bridge oxidizes in less than about 1 hour after initial contact with a conductive aqueous medium. In other embodiments, the bridge oxides in less than about 30 minutes, less than about 20 minutes, or less than about 10 minutes.

C. Exemplary Layer Thickness

FIGS. 13A to 13G depict several exemplary embodiments of differing layer thickness for the cathode case. A layer may also be referred to as a foil, a surface, a film, or a sheet. The overall thickness of the cathode case ranges from about 200 μm to about 360 sm.

In some embodiments, the outer conductive layer 1304 may have a uniform (FIGS. 13A-13D) or varying thickness (FIG. 13E) ranging from about 100 nm to about 400 μm. In some embodiments, the outer conductive layer has a thickness ranging from about 100 nm to about 400 μm, about 100 nm to about 350 μm, about 200 μm to about 350 μm, about 1 μm to about 50 μm, about 5 μm to about 50 μm, about 50 μm to 250 μm, or about 5 μm to about 200 μm.

In some embodiments, the inner conductive layer 1303 has a uniform or variable thickness ranging from about 100 nm to about 400 μm. In some embodiments, the inner conductive layer has a thickness ranging from about 100 nm to about 350 μm, about 1 μm to about 350 μm, about 200 μm to about 350 μm, about 1 μm to about 50 μm, about 5 μm to about 50 μm, about 50 μm to 250 μm, or about 5 μm to about 200 μm.

In some embodiments, the insulating layer 1305 has a uniform or varying thickness ranging from about 1 μm to about 400 μm. In some embodiments, the insulating layer has a thickness ranging from about 1 μm to about 350 μm, about 200 μm to about 350 μm, about 1 μm to about 50 μm, about 5 μm to about 50 μm, about 50 μm to 250 μm, or about 5 μm to about 200 μm.

In certain embodiments, the insulating layer includes an internal support 1317 having a uniform or varying thickness ranging from about 200 μm to about 356 μm (FIGS. 13F and 13G). In some embodiments, the internal support is fully coated (FIG. 13F) or partially coated (FIG. 13G) in a non-conductive film 1305, which forms the insulating layer. The non-conductive film 1305 is subsequently coated with a conductive layer 1318 which comprises an inner film 1318a, an outer film 1318b, and a rim film 1318c where films 1318a, 1318b, and 1318c are all in electrical contact. The inner conductive film 1318a functions as the inner conductive layer and the rim film 1318c functions as the bridge. In the embodiment illustrated in FIG. 13F, the outer film 1318b functions as the outer conductive layer and covers the annular side 1312 and bottom 1313 of the cathode case. In the embodiment illustrated in FIG. 13G, the outer film 1318b is in physical and electrical contact with a conductive internal support 1317a resulting in an outer conductive layer that comprises the outer film 1318b and internal support 1317a. The outer film 1318b partially or fully covers the annular side 1312 and bottom 1313 of the cathode case.

The at least one bridge may have a uniform or varying thickness ranging from about 100 nm to about 50 μm.

Methods for forming layers having the above described thicknesses are known in the art. For example, physical vapor deposition is useful for forming layers having a thickness of about 100 nm to about 10 μm. Cladding, welding, pinching, or stamping are useful processes for forming layers having a thickness ranging from about 1 μm to about 400 μm.

III. Exemplary Contact with a Conductive Aqueous Medium

Contact of a battery with a conductive aqueous medium includes immersing a battery in a conductive aqueous medium or contacting the battery with a wet tissue, such as tissues of the mouth, throat, esophagus, or any other part of the GI tract of a mammal. In some embodiments, the contact with the conductive aqueous medium comprises placement of the battery on a hydrated tissue such that the at least one bridge and at least a part of the anode case is in contact with the hydrated tissue. In some embodiments, the hydrated tissue is hydrated ham, while in other embodiments, the tissue is hydrated pig esophageal tissue.

In another embodiment, the contact with the conductive aqueous medium comprises immersion of the battery, anode terminal facing up, in the conductive aqueous medium. In one embodiment, the conductive aqueous medium is about 20 mL of 0.85% w/w saline solution or about 20 mL of 25% Ringers solution with an initial pH ranging from about 5 to about 7, and after the battery is immersed, the average pH of the saline solution over the first 60-minute time period does not exceed an average pH of about 10 with a sampling interval of every 5 minutes, 25% Ringer's solution contains 36.75 mM sodium chloride, 1.00 mM potassium chloride, and 0.75 mM calcium chloride. The pH should be measured directly in the solution container about 3 cm above the center of the anode case with either pH paper or a digital pH meter without mixing. In yet another embodiment, the pH of the solution does not exceed about 9.5 for a time period of 10 to 60 minutes after immersion. In another embodiment, the pH of the solution does not exceed 9 for a time period of from 10 to 60 minutes after immersion. In yet another embodiment, the pH of the solution does not exceed about 8.5 for a time period of 10 to 60 minutes after immersion. In yet another embodiment, the pH of the solution does not exceed about 8 for a time period of 10 to 60 minutes after immersion. In yet another embodiment, the pH of the solution does not exceed about 7.5 for a time period of 10 to 60 minutes after immersion.

In another embodiment, after immersion of the battery in 20 mL of a 0.85% w/w saline solution or 20 mL of 25% Ringers solution having a pH of about 5 to 7 at room temperature for at least 1 hour, the electrical resistance between the inner conductive layer and the outer conductive layer is greater than about 500 ohms, greater than about 50 kohms, or greater than about 500 kohms. In another embodiment, the connection between the inner conductive layer and the outer conductive layer becomes an open circuit. In another embodiment, the current between the inner conductive layer and the outer conductive layer is less than about 0.1 mA, lesser than about 0.01 mA, or lesser than about 1 μA.

In some embodiments, the battery is immersed with anode side facing up in about 20 mL of the about 0.85% saline solution or about 20 mL of 25% Ringers solution.

### IV. Exemplary Laminates

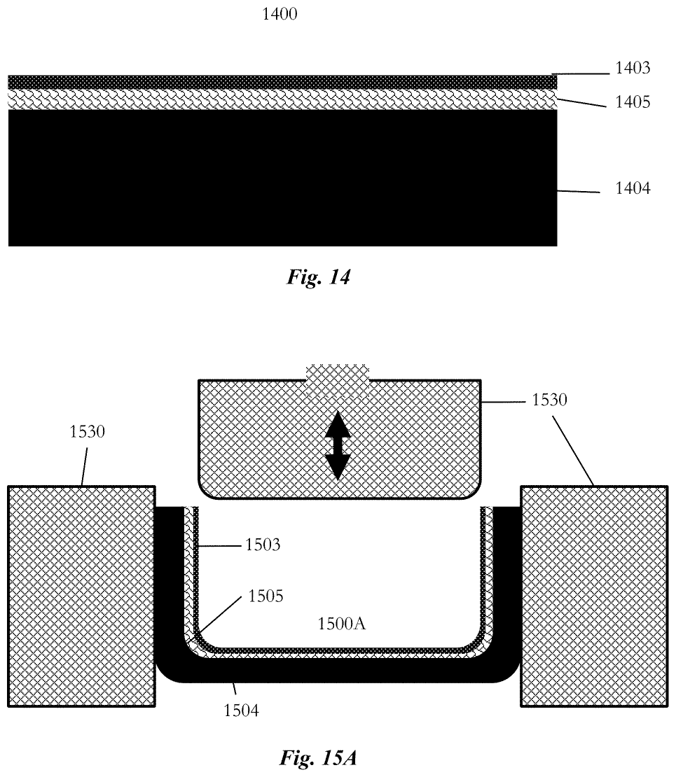

Next, the present disclosure provides multi-layer laminates that are useful for forming an electrode case. An exemplary multi-layer laminate 1400 is depicted in FIG. 14, where 1403 represents a first conductive layer, 1404 represents a second conductive layer, and 1405 represents an insulating layer. The insulating layer is between the first and second conductive layers. The first and second conductive layers can be in electrical contact after a physical or chemical process to form at least one bridge between the first and second conductive layers.

The multi-layer laminates may advantageously be used to form an electrode case, such as a cathode case, for a battery as described herein, and after contact of the at least one bridge with a conductive aqueous medium, the electrical contact between the first and the second conductive layers is reduced or severed.

The first conductive layer may comprise any conductive material. In some embodiments, the first conductive layer comprises aluminum, stainless steel, nickel, chromium, tungsten, vanadium, or a combination of any two or more thereof. The second conductive layer also may comprise any conductive material. Metals useful for the second conductive layer include, without limitation, stainless steel, aluminum, titanium, or a combination of any two or more thereof.

In a particular embodiment, the second conductive layer comprises stainless steel. Useful stainless steels include, without limitation, SS304, SS316, SS430, a duplex stainless steel, steel with a chromium contact greater than or equal to about 10% by weight and a nickel content greater than or equal to about 0.1% by weight, or a combination of any two or more thereof.

The insulating layer may be, in some embodiments, a hydrophobic polymer, a natural rubber, a silicone elastomer, a cellulose acetate, a paper dielectric, a ceramic, a metal oxide, a nitride, a carbide, or a combination of any two or more thereof. The hydrophobic polymer may be polyethylene terephthalate, a polytetrafluoroethylene, a fluorinated ethylene propylene, a polyvinyl fluoride, a polyvinylidine difluoride, a polypropylene, a polyurethane, a polyimide, a dimethylpolysiloxane, an adhesive, an anodized aluminum, or a combination of any two or more thereof. Useful metal oxides include is aluminum oxide, nickel oxide, chromium oxide, or a combination of any two or more thereof.

In some embodiments the insulating layer further comprises: a) multiple layers; b) a multilayered construction including an adhesive layer in contact with the outer conductive layer; c) a multilayered construction including an adhesive layer in contact with the inner conductive layer; or d) a) b) and/or c).

The adhesive layers of the multilayered insulating layer may comprise a pressure-sensitive adhesive, a rubber-based adhesive, an epoxy, a polyurethane, a silicone adhesive, a phenolic resin, a UV curable adhesive, an acrylate adhesive, a laminating adhesive, a fluoropolymer, or any combination of two or more thereof.

The at least one bridge that may be formed with the laminate may comprises a material that is capable of electrochemical dissolution in a conductive aqueous medium. Useful materials for the bridge include stainless steel, aluminum, chromium, magnesium, nickel, copper, zinc, or a combination of any two or more thereof.

In some embodiments, the first conductive layer has a uniform or variable thickness ranging from about 100 nm to about 400 μm, 100 nm to about 350 μm, 1 μm to about 350 μm, about 200 μm to about 350 μm, about 1 μm to about 50 μm, or about 50 μm to 200 μm.

In some embodiments, the second conductive layer may have a uniform or varying thickness ranging from about 100 nm to about 400 μm, about 100 nm to about 350 μm, about 1 μm to about 350 μm. In some embodiments, the second conductive layer has a thickness ranging from about 200 μm to about 350 μm, about 1 μm to about 50 μm, or about 50 μm to 200 μm.

In some embodiments, the insulating layer has a uniform or varying thickness ranging from about 100 nm to about 400 μm, about 100 nm to about 350 μm, about 1 μm to about 350 μm, about 200 μm to about 350 μm, about 1 μm to about 50 μm, or about 50 μm to 200 μm.

In certain embodiments, the insulating layer includes an internal support having a uniform or varying thickness ranging from about 200 μm to about 356 μm.

The at least one bridge may have a uniform or varying thickness ranging from about 100 nm to about 50 μm.

### V. Exemplary Methods of Manufacture

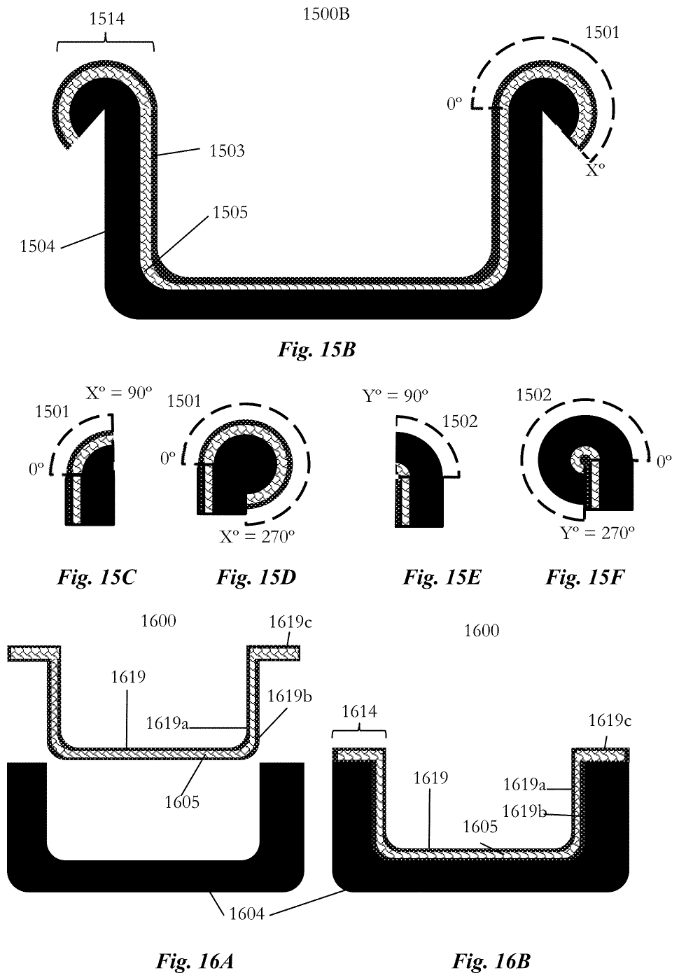

The present disclosure further provides methods for manufacturing the aforementioned exemplary cathode cases and exemplary batteries. Several methods are available, including the following non-limiting examples. In one embodiment depicted in FIG. 15A, a method of manufacturing a cathode case comprises:

a) providing a laminate having a first conductive layer 1503, a second conductive layer 1504, and an insulating layer 1505 between the first and the second conductive layers;

b) stamping 1530 the laminate to form a cathode case 1500A comprising a bottom, an annular side, and a rim; and

c) forming at least one bridge between the first and the second conductive layers, wherein the first conductive layer forms an interior surface of the case, and the second conductive layer forms an exterior surface of the case.

In some embodiments, the bridge may be formed by crimping the rim. Alternatively, the stamping process forms the bridge. In another embodiment as depicted in FIG. 15B, a method of manufacturing a cathode case 1500B comprises rolling the edge of the can to wrap the interior surface over the rim 1514 of the can away from the center of the can 1501. In some embodiments, the first conductive layer 1503 makes physical and electrical contact with a second conductive layer 1504 when the edge of the can is rolled by at least 270° or more as shown in the close-up cathode can rim schematic in FIG. 15C. In still other embodiments, the edge of the can is rolled away from the center of the can to an angle X°, wherein X° is measured relative to 0° being parallel to the bottom of the can, 1501, wherein X° may range from about 1° to 270°, about 5° to 200°, about 45° to 135°, about 270° to 360°, or about 360° to 720° (FIGS. 15C and 15D). In yet another embodiment, the edge of the can is rolled inwards towards the center of the can 1502 as shown in FIGS. 15E and 15F. In still other embodiments, the edge of the can is rolled towards the center of the can to an angle Y°, wherein Y° is measured relative to 0° being parallel to the bottom of the can, 1502, wherein Y° may range from about 1° to 270°, about 5° to 200°, about 45° to 135°, about 270° to 360°, or about 360° to 720°. In some embodiments where the edge of the can is rolled inwards, the cathode can may be crimped in a shape where a portion of the inner conductive layer near the roll over is available to become the bridge and oxidize when immersed in a conductive aqueous medium to break the connection.

In other embodiments, where the edge of the can is rolled in either direction (FIGS. 15D and 15F), but the first conductive layer does not make physical contact with a second conductive layer, the bridge may be formed by soldering, vapor depositing, plating, brazening, printing with conductive ink, or otherwise affixing a bridge material to the first conductive layer and/or the second conductive layer.

The at least one bridge may comprise a portion of the first conductive layer in electrical contact with the second conductive layer. Alternatively, the at least one bridge may comprise a portion of the second conductive layer in electrical contact with the first conductive layer.

In some embodiments, the at least one bridge comprises a conductive wire, a conductive strip, or a conductive sheet. A plurality of bridges of may be formed, or a single bridge may be formed.

In another embodiment, a method of manufacturing a cathode case having an internal support in the insulating layer comprises:

a) providing an internal support comprising a bottom, an annular side, a rim, an interior surface, and an exterior surface:

b) depositing an insulating layer on the interior, the exterior and the rim of the internal support;

c) depositing a first conductive material on the insulating layer on the interior surface and optionally the rim, thereby forming an inner conductive layer;

d) depositing a second conductive material on the insulating layer on the exterior surface and optionally the rim, thereby forming an outer conductive layer;

wherein the inner conductive layer and the outer conductive layers are in contact via at least one bridge (FIGS. 13F and 13G).

FIGS. 16A-20B depict schematics of additional methods for assembling a cathode case 1600. In FIGS. 16A and 16B, an insulating layer 1605 is formed into a cup shape separately from the outer conductive layer 1604. The insulating layer is then covered with a conductive film 1619 which comprises an inner film 1619a, an outer film 1619b, and a rim film 1619c where films 1619a, 1619b, and 1619c are all in electrical contact. The insulating layer with the conductive film is then mechanically fit into the outer conductive layer to form the cathode case. In this embodiment, the insulating layer with the conductive film covers the entirety of the cathode case rim 1614. The layers can be secured mechanically through pressing, stamping, or crimping and/or through conductive and non-conductive adhesives. In some embodiments, the insulating layer with the conductive film only partially covers the rim as shown in FIGS. 16C and 16D.

FIGS. 17A and 17B depict an exemplary manufacturing scheme in which the inner conductive layer 1720 is deposited on one side of the insulating layer 1705, which is in the shape of a cathode case with an extended edge. The inner conductive layer 1720 which comprises an inner surface 1720a, an outer surface 1720b, and a rim surface 1720c where surfaces 1720a, 1720b, and 1720c are all in electrical contact. The edges of the insulating layer are folded over to form a conductive surface that will be exposed on the rim 1720c, and a conductive surface 1720b that will be in direct physical and electrical contact with the outer conductive layer 1704. The outer conductive layer is then applied by either pressing the insulating layer into it or by deposition of the outer conductive layer material on the insulating layer.

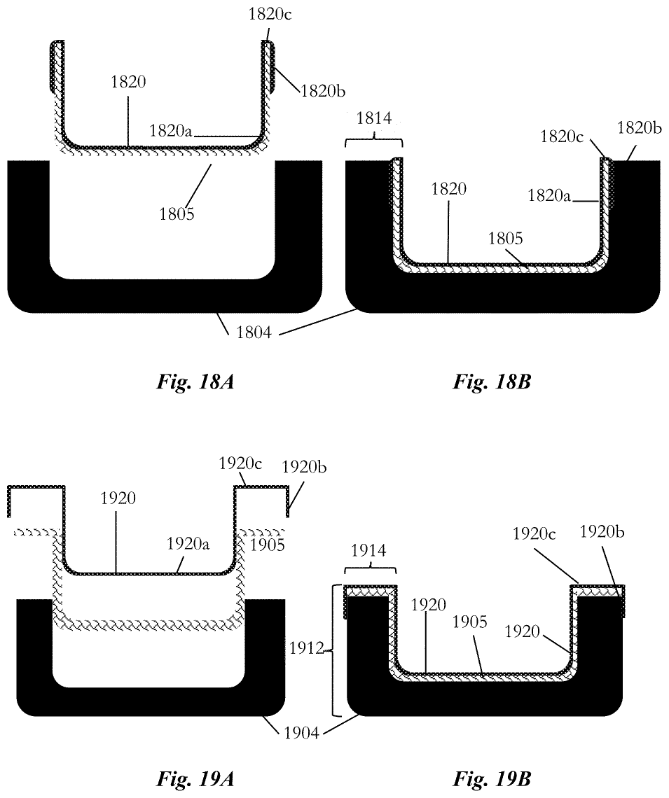

In another embodiment, depicted in FIGS. 18A and 18B, the insulating layer 1805 has a conductive film 1820 deposited on the inside and folded over the rim of the insulating layer such that there is an inner film 1820s, an outer film 1820b, and a rim film 1820c. The insulating layer and conductive film can be inserted into the outer conductive layer 1804, as in FIG. 18B.

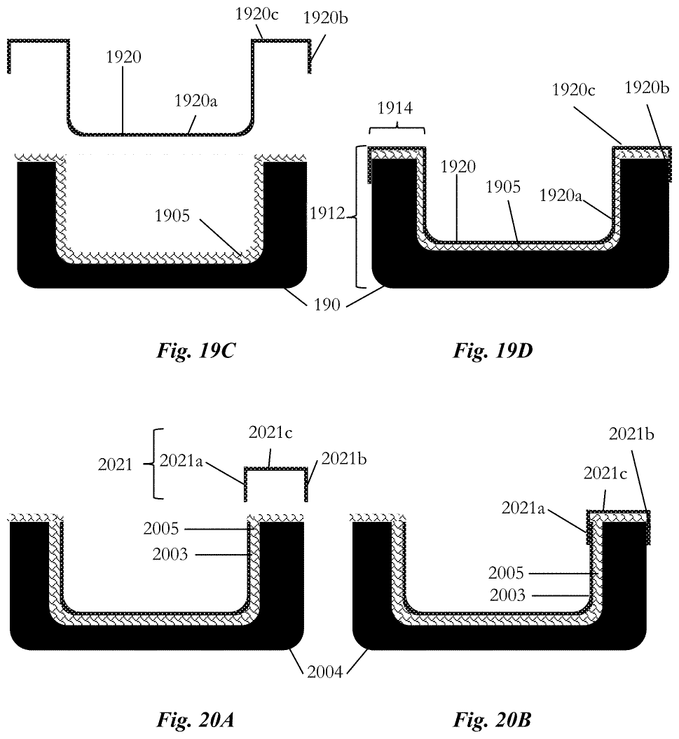

FIGS. 19A and 19B depict an exemplary manufacturing scheme in which the inner conductive layer 1920, the outer conductive layer 1904, and the insulating layer 1905 are all formed separately and mechanically joined in a secondary assembly step. The inner conductive layer 1920 comprises three sections; the inner section 1920a, the outer section 1920b, and the bridge section 1920c. The inner conductive layer bridge section and outer section extend over the cathode can rim 1914 and contacts the annular wall 1912 of the outer conductive layer 1904. The bridge section of the inner conductive layer 1920c functions as the bridge, and the outer section in contact with the annular side of the outer conductive layer 1920b functions to secure electrical contact through stamping, pinching, crimping, soldering, welding, or applying a conductive adhesive. In some embodiments, the insulating layer 1905 and outer conductive layer 1904 are formed into the shape of a cathode case together and the inner conductive layer 1920 is formed separately then combined to complete the cathode can (FIGS. 19C and 19D).

Yet another manufacturing process is shown in FIGS. 20A and 20B, wherein a laminate, such as laminate 1400 shown in FIG. 14, is stamped so the inner conductive layer 2003, the outer conductive layer 2004, and the insulating layer 2005 are all formed together without a bridge. A separate strip of conductive foil 2021 comprising an inner conductive section 2021a, a rim section 2021c, and an outer conductive section 2021b is placed over the rim to form the bridge.

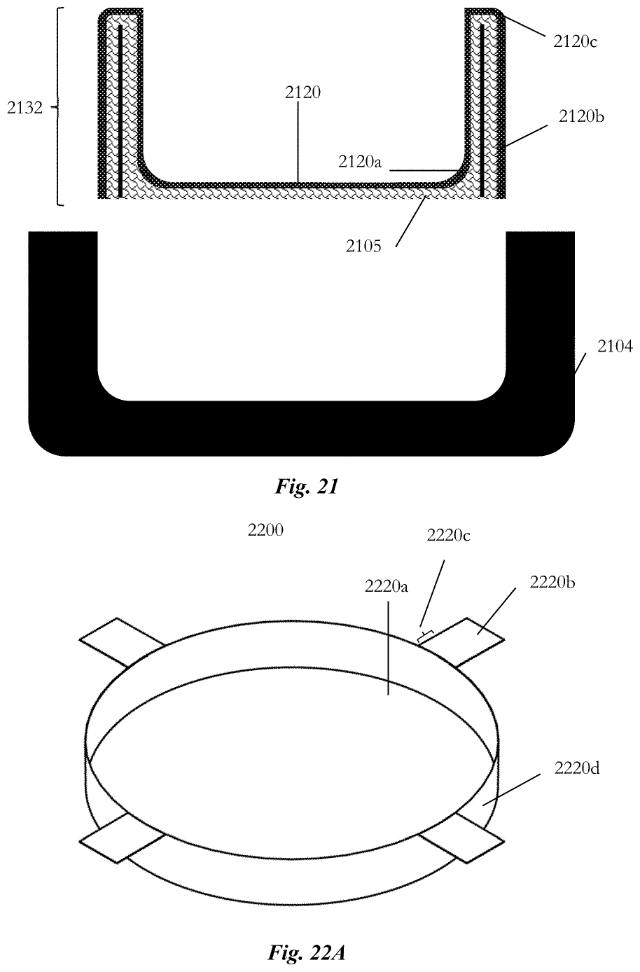

In another embodiment depicted in FIG. 21, a laminate 2132 comprising a conductive layer 2120 and an insulating layer 2105 is formed into a cup-shaped laminate having a flange. The flange is folded over at rim 2120c to form a continuous conductive layer from the inside of the cup 2120a to the outer walls 2120b. The bottom of the cup-shaped laminate comprises the insulating layer 2105. The cup-shaped laminate 2132 is placed into a cathode can 2104 to complete the cathode case. This embodiment is referred to as the “double-fold” herein.

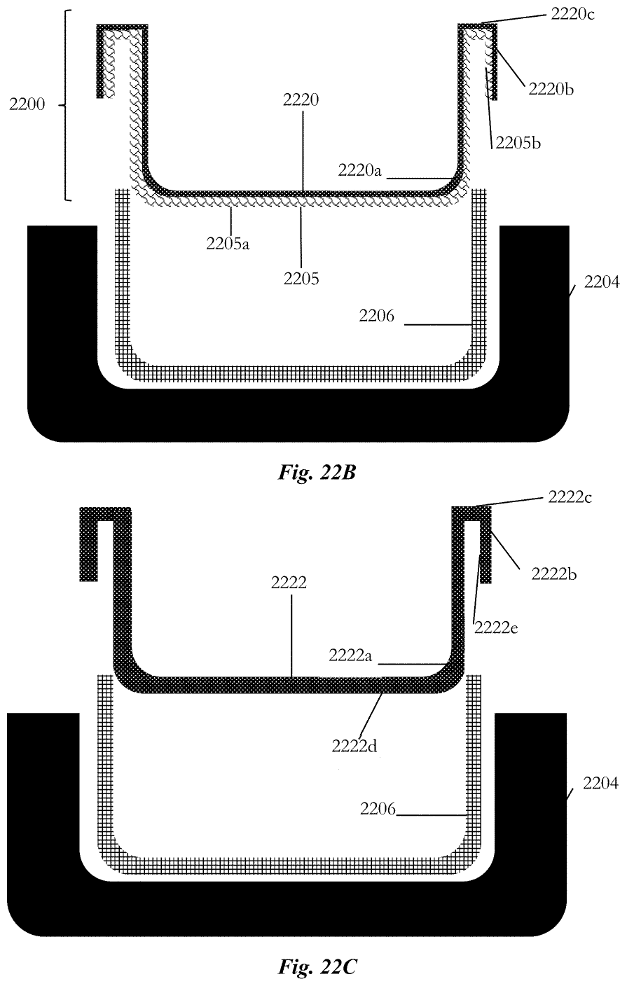

In another embodiment depicted in FIGS. 22A, 22B, and 22C, a cup-shaped insert 2200 with an inner conductive layer 2220 comprises an inner area 2220a, an outer area 2220d, and one or more tabs 2220b. A smaller area of the tab 2220c may be used to make the bridge. In some embodiments, the cup-shaped inner conductive layer comprises from 2 to 10 tabs, from 2 to 8 tabs, from 4 to 6 tabs, or 4 tabs. In some embodiments, as depicted in FIG. 22B, a laminate insert 2200 comprises a cup-shaped inner conductive layer 2220 and a cup-shaped insulating layer 2205 having a plurality of tabs. The cup-shaped inner conductive layer 2220 comprises of an inner area 2220a, a bridging area 2220c, and a tab area 2220b. In some embodiments, the cup-shaped laminate comprises from 2 to 10 tabs, from 2 to 8 tabs, from 4 to 6 tabs, or 4 tabs. FIG. 22B depicts an exemplary cup-shaped laminate having four tabs 2220b, an inner area 2220a comprising an inner conductive layer and an insulating layer 2205. The tabs 2220b then may be folded at rim to form the bridging area 2220c. The insulating layer 2205 comprises of an inner area 2205a and a tab area 2205b. The cup-shaped laminate may be placed inside a cup-shaped thermoform 2206 comprising an insulating material using, for example, a press fit or an adhesive. The cup-shape thermoform 2206 is used primarily to support the shape of the overall insert. As shown in FIG. 22B, an adhesive may be applied to the insulating side of the tabs 2205b and/or to the insulating layer on bottom of cup-shaped laminate 2205a prior to placement in the cup-shaped thermoform 2206. The cup-shaped laminate and thermoform are then placed inside an outer conductive layer 2204 to complete the cathode case.

In another embodiment depicted in FIG. 22C, a conductive foil may be stamped or otherwise formed into a cup-shaped inner conductive layer 2222 with tabs having a shape similar to the cup-shaped inner-conductive layer of FIG. 22A. The cup-shaped inner conductive layer 2222 comprises of an inner surface 2222a, a bridging surface 2222c, a top tab surface 2222b, a bottom surface 2222d, and a bottom tab surface 2222e. The cup-shaped inner conductive layer may be placed inside a cup-shaped insulating layer 2206, such as a cup-shaped thermoform, using, for example, a press fit or an adhesive. In this case, the cup-shaped thermoform 2206 is used primarily as the insulating layer and also lends structural support to the insert. For example, adhesive may be applied to the bottom tab surface 2222e and/or to the bottom of cup-shaped inner conductive layer 2222d prior to inserting into the thermoform. The combined inner-conductive layer and thermoform is then placed into an outer conductive layer 2204 to complete the cathode case.

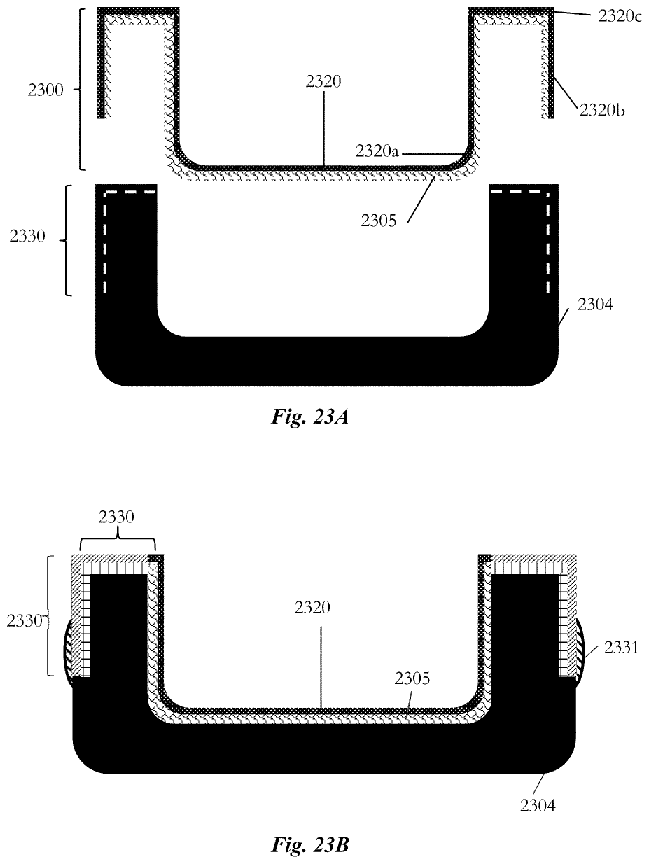

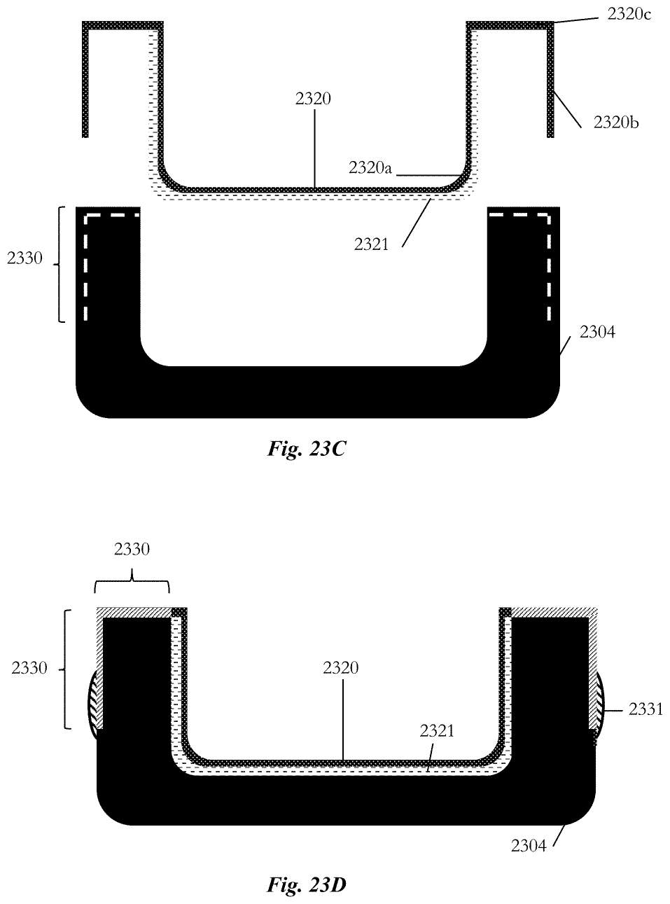

In another embodiment depicted in FIGS. 23A and 23B, a laminate 2300 comprising a conductive foil 2320 and an insulating layer 2305 is stamped into a cup shape having one or more tabs, such as the shape as shown in FIG. 23. The conductive foil 2320 comprises an inner surface 2320a, a tab surface 2320b, and a bridging surface 2320c. The cup-shaped laminate is placed inside a cathode can 2304 having one or more channels 2330 corresponding to the one or more tabs of the laminate. The tabs 2320b are folded into the channels 2330. The depth of the channels may range from about 25 μm to about 50 μm, in some embodiments. The laminate cup and the cathode can may be press fit or adhered with an adhesive. A low temperature solder or a conductive adhesive 2331, such as silver epoxy, may be used to complete the electrical connection between the inner conductive layer and outer conductive layer.

In another embodiment depicted in FIGS. 23C and 23D, a foil is formed into a cup shape with tabs as depicted in FIG. 22A, for example by stamping. The foil cup 2320 comprises an inner surface 2320a, a tab surface 2320b, and a bridging surface 2320c. The foil cup 2320 is then placed in a thermoform cup 2321 that serves as the insulating layer and is secured by a press fit or an adhesive. The tabs on the cup-shaped foil align with channels 2330 on cathode case 2304. A low-temperature solder or a conductive adhesive 2331, such as silver epoxy, may be used to complete the electrical connection between the inner conductive layer and outer conductive layer.

In some embodiments of any of the aforementioned methods of manufacture, an insulating material is formed into a cup-shaped insulating layer by thermoforming. Alternatively, the insulating layer may be formed into a cup shape by molding. In some embodiments, the molding produces a cup-shaped insulating layer having a thickness ranging from about 10 μm to about 100 μm thick.

In some embodiments of the aforementioned manufacturing methods, the inner conductive layer can be formed by casting a conductive metal to form a cup. In some embodiments, the cast conductive metal cup can fit inside a cup-shaped insulating layer. In one embodiment, aluminum or an aluminum alloys can be cast to form a cup having a thickness ranging from about 5 μm to about 50 μm. Casting advantageously may prevent wrinkling that may happen during a stamping or forming process. The cast conductive layer may further include a plurality of tabs, for example, as depicted in FIG. 22A.

The resistance of the cathode case can be measured using a four probe milliohm meter (Extech Model #380580) for quality control. As depicted in FIGS. 24A, 24B, and 24C, an exemplary cathode case 2402 comprising inner conductive layer 2403, outer conductive layer 2404, insulating layer 2405 and bridge 2410 is placed between two sets of radial probes 2440 and 2441. One example of a 4 probe radial fixture is a Gamry Universal Battery holder (FIG. 24A). The resistance is measured from the inside of the inner conductive layer 2403 through the bridge 2410 and to the outer conductive layer 2404 as described in FIG. 24C.

The measurement of internal resistance of the battery is known in the art. One method for measuring internal resistance is measuring the AC impedance at 1 kHz using a Gamry potentiostat.

In some manufacturing processes, the assembled cell is sprayed or immersed in a nonconductive aqueous medium shortly after assembly to presumably remove any excess material and/or solvent in a manner that does not interfere with the battery stability or performance.

In some embodiments, a battery as disclosed herein may not deactivate in a non-conductive aqueous medium. In some embodiments, deactivation occurs when the voltage of the battery decreases to 1.23V or lower when the battery is dry and when the battery voltage is measured in series with a 15 kohm resistor. For example, deactivation of a battery disclosed herein may not occur after immersion of in a nonconductive aqueous medium for up to 1 minute, for up to 10 minutes, for up to 1 hour, for up to 3 hours, for up to 1 day, or for up to 10 days.

In some embodiments, the internal resistance of a battery as disclosed herein may increase by less than about 1 ohm, by less than about 10 ohm, by less than about 20 ohm, by less than about 100 ohm, or by less than about 500 ohm after immersion of the battery in a nonconductive aqueous medium for up to about 1 minute, for up to about 10 minutes, for up to about 1 hour, for up to about 3 hours, for up to about 1 day, or for up to about 10 days.

In some embodiments, the resistance of an exemplary battery measured between the inner conductive layer and the outer conductive layer may increase by less than about 1 ohm, by less than about 10 ohm, by less than about 20 ohm, by less than about 100 ohm, or by less than about 500 ohm after immersion of the battery in a nonconductive aqueous medium for up to about 1 minute, for up to about 10 minutes, for up to about 1 hour, for up to about 3 hours, for up to about 1 day, or for up to about 10 days.

In some embodiments, the internal resistance of the battery does not increase by more than about 500 ohms, or does not increase by more than about 100 ohms, or does not increase by more than about 50 ohms, or does not increase by more than about 20 ohms after immersion of the battery in a non-conductive aqueous medium from about 1 min to 180 minutes, or from about 1 min to 60 min, or from about 1 min to 10 min.

In some embodiments, the shelf-life stability of a battery may be estimated by testing the battery after storage in conditions more extreme than typical storage conditions.

In some embodiments, the battery is stored in an environment having a temperature in the range of about −20° C. to about 60° C. In some embodiments, the internal resistance of the battery does not increase by more than about 500 ohms, or does not increase by more than about 100 ohms, or does not increase by more than about 50 ohms, or does not increase by more than about 20 ohms after storing the battery in an environment having a temperature in the range of −20° C. to 60° C., or in the range of about 40° to about 60, such as at a temperature of about 40° C., about 45° C., about 50° C., about 55° C., or about 60° C. In some embodiments, the internal resistance of the battery does not increase by more than about 500 ohms, or does not increase by more than about 100 ohms, or does not increase by more than about 50 ohms, or does not increase by more than about 20 ohms after storing the battery in an environment having any of the above temperatures for more than about 2 hours, or from about 2 hours to 60 days, or from about 120 hours to 20 days, or from about 60 days to 1 year.

In some embodiments, the battery is stored in an environment having a relative humidity (RH) in the range of from 0 to 100% RH, such as about 30% h to about 90% RH. In some embodiments, the internal resistance of the battery does not increase by more than about 500 ohms, or does not increase by more than about 100 ohms, or does not increase by more than about 50 ohms, or does not increase by more than about 20 ohms when stored in an environment having a relative humidity of about 95% or lower, or a relative humidity of about 90% or lower, or between 30% to 90% RH. In some embodiments the internal resistance of the battery does not increase by more than about 500 ohms, or does not increase by more than about 100 ohms, or does not increase by more than about 50 ohms, or does not increase by more than about 20 ohms after storing the battery in an environment having any of the above relative humidity values for more than about 2 hours, or from 2 hours to 60 days, or from 120 hours to 20 days, or from 60 days to 1 year.

In still other embodiments, the internal resistance of the battery does not increase by more than about 500 ohms, or does not increase by more than about 100 ohms, or does not increase by more than about 50 ohms, or does increase by more than about 20 ohms after being stored in an environment having a temperature of from 40° C. to 60° C. for 2 hours to 7 days.

In some embodiments, the internal resistance of the battery does not increase by more than about 500 ohms, or does not increase by more than about 100 ohms, or does not increase by more than about 50 ohms, or does not increase by more than about 20 ohms when the battery is stored in the environment having relative humidity of about 95% or lower, or when the battery is stored in the environment having relative humidity of about 95% or lower, for more than about 2 hours, or from 2 hours to 60 days, or from 2 hours to 20 days, or from 120 hours to 7 days, or from 7 days to 60 days.

In other embodiments, the internal resistance of the battery does not increase by more than about 500 ohms, or does not increase by more than about 100 ohms, or does not increase by more than about 50 ohms, or does not increase by more than about 20 ohms when the battery is stored in an environment having relative humidity of about 30% to about 90% for about 2 hours to about 7 days.

In some embodiments, the internal resistance of the battery does not increase by more than about 500 ohms, or does not increase by more than about 100 ohms, or does not increase by more than about 50 ohms, or does not increase by more than about 20 ohms when the battery is stored in an environment having relative humidity of from about 30% to about 90% and a temperature of from about 40° C. to about 45° C. for about 2 hours to 7 days.

### EXAMPLES

### Example 1

A. Manufacture of an Example Battery

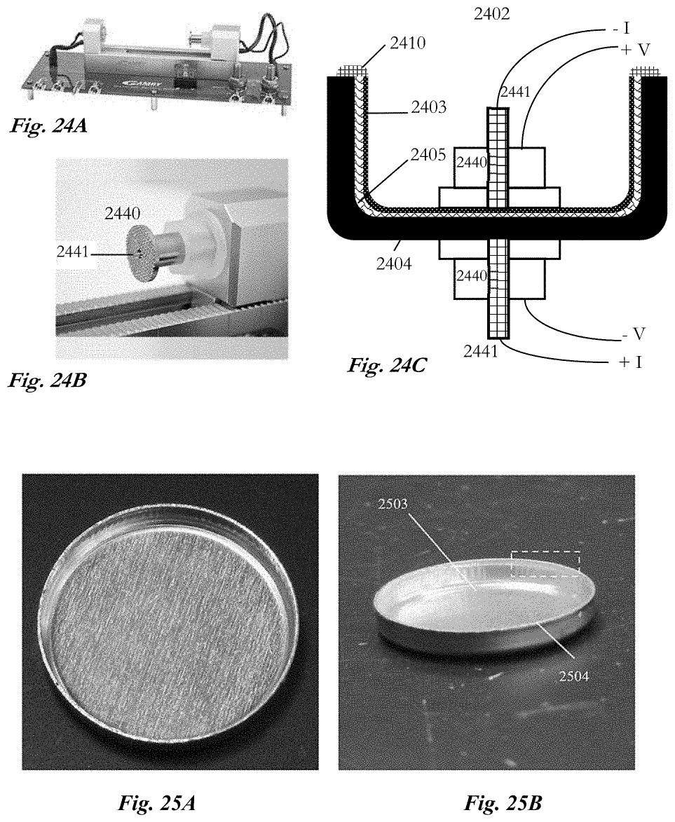

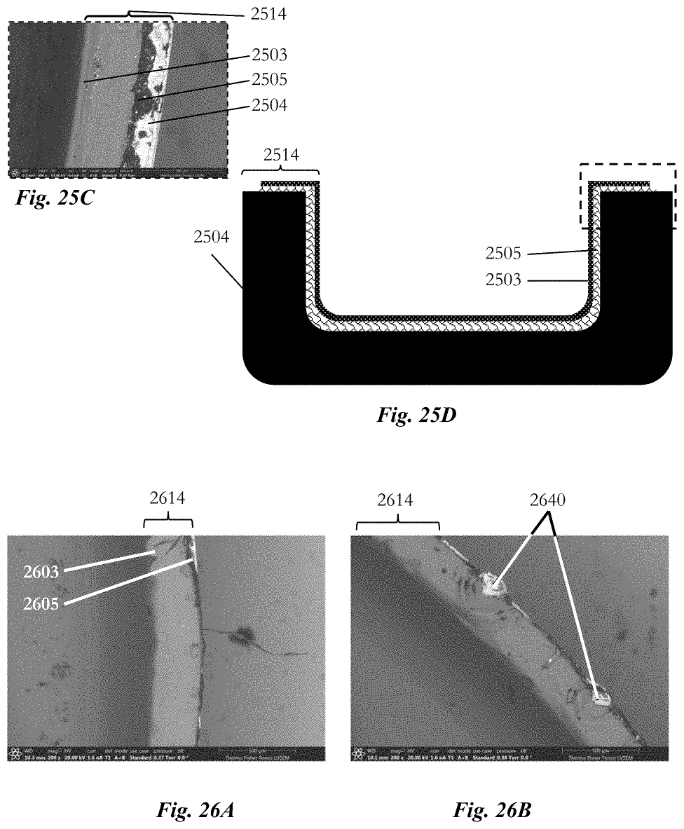

An exemplary cathode case is shown in FIGS. 25A and 25B. In this example, polyethylene terephthalate (PET) with a pressure-sensitive adhesive and laminating adhesive is used as the insulating layer, aluminum is used as the inner conductive layer 2503, and stainless steel 304 is used as the outer conductive layer 2504. An extension of the aluminum layer forms the bridge by electrically contacting the stainless steel outer conductive layer. In FIG. 25C, the top down view Scanning Electron Microscope (SEM) image shows inner conductive layer 2503, insulating layer 2505, and the aluminum foil 2503 extending over the rim 2514 of the case. Energy-dispersive X-ray Spectroscopy (EDX) analysis reveals that the gray color is aluminum, the black color is hydrocarbon, and the light gray color is stainless steel. FIG. 25D is a schematic depicting the construction of the cathode case of FIGS. 25A-C. The batteries were then assembled with commercially available lithium anodes and manganese dioxide cathodes and crimped.

FIGS. 26A and 26B are top down view SEM images of the rim 2614 of another exemplary laminate cathode case before and after ultrasonic welding, respectively. The aluminum foil 2603 extends across the rim 2614, and portions of insulating layer 2605 are visible. Ultrasonic weld points 2640 create a bridge between the aluminum and stainless-steel outer conductive layer.

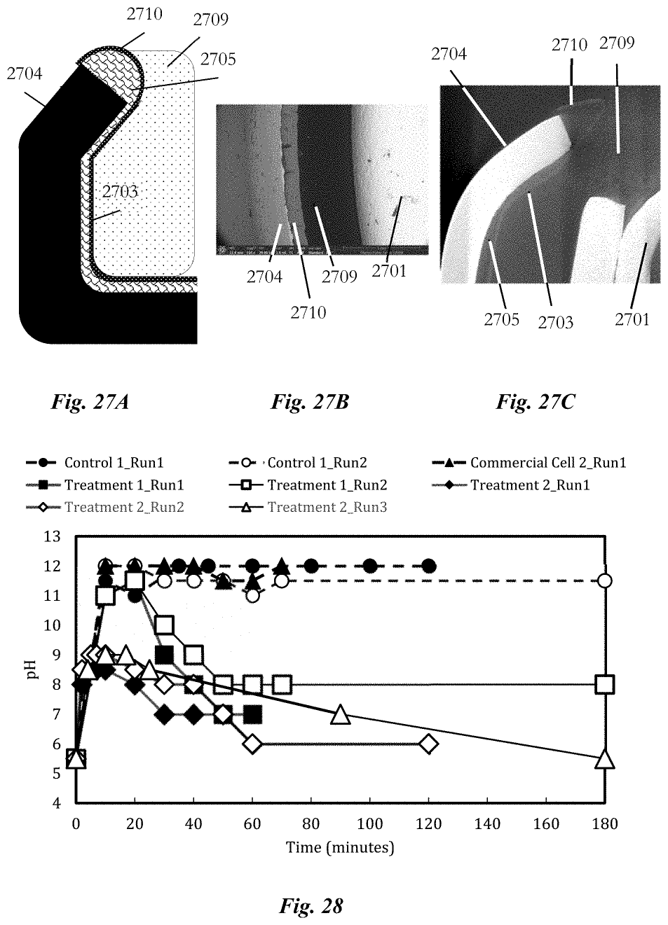

FIGS. 27A-C depict an example cathode case used in assembling a CR2032 lithium battery. FIG. 27A is a schematic of the crimped cathode case depicting outer conductive layer 2704, inner conductive layer 2703, insulating layer 2705, gasket 2709, and bridge 2710. In FIG. 27B, a top down view SEM image of the crimp area of the assembled battery is shown, where the outer conductive layer 2704, bridge 2710, gasket 2709, and anode case 2701 are visible. In FIG. 27C, an X-ray tomography scan from the side view of the battery reveals the internal structure of the crimped cathode case.

B. Comparative Tests of Control Batteries and Example Batteries

The results of exposing a commercial Maxell CR2032 lithium control battery, a lab-made control battery, and the treatment example battery to saline, 25% Ringers solution, deionized water, hydrated esophageal tissue, and hydrated ham are reported below. These tests simulate the activity of the batteries under biologic conditions (e.g., after being swallowed and reacting with living tissue).

i) Immersion in Saline

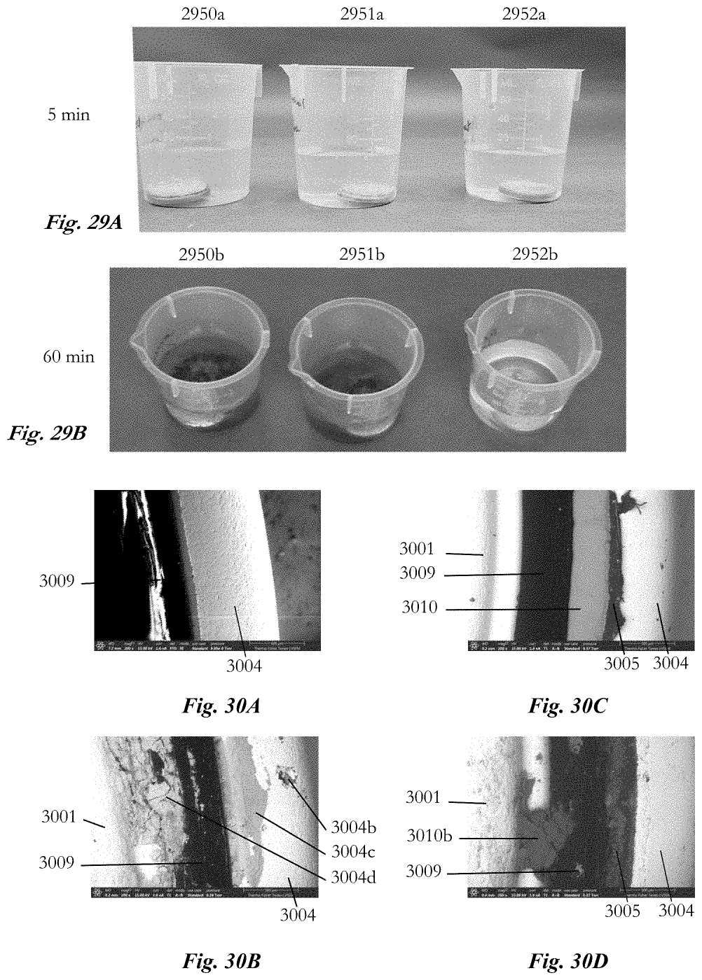

FIG. 28 is a graph showing the change in pH over a 3-hour period when the commercial batteries and treatment example batteries were immersed in 20 mL of 0.85% saline solution having a starting pH of about 5.5. This result is visually reflected, as shown in FIGS. 29A and 29B. There was a slight increase in pH of the saline solution after exposure to the treatment example cell 2952a and 2952b, within 5 minutes, after which the pH stayed consistently low over the remainder of the test for the example cell. By contrast, the pH of the saline solution rose to a pH of 11-12 over the same period after exposure to both the commercial Maxell CR2032 lithium control 2950a and 2950b and the lab-made control batteries 2951a and 2951b. FIG. 29B shows the corrosion byproducts which caused a color change to the solution and metal oxide deposits around the cells in the first and second cups. By contrast, in the third cup, the solution was clear and nearly colorless, and no visible iron oxide forms on the example battery. The treatment example battery continued to show no additional corrosion while continuing to be immersed in saline over 24 to 48 hours, while the control batteries continued to corrode. (Data not shown).

The lab-made control and treatment example batteries were examined by scanning electron microscopy (SEM) before and after the immersion in saline experiment. Following the experiment, the batteries were dried for at least 24 hours in a desiccator. The top down view of the crimp area of the lab-made control is shown before saline immersion in FIG. 30A and after immersion in FIG. 30B. Significant corrosion occurred on the outer surface of the cathode case 3004. There is evidence of pitting 3004b and oxide formation directly on the cathode 3004c as well as oxide formation in powder form 3004d near the gasket 3009 and anode 3001. The oxide 3004c and 3004d were identified as iron oxide by Energy Dispersive X-ray Spectroscopy (EDX). 10199I FIG. 30C shows the treatment example battery before immersion. The bridging aluminum foil 3010 is fully intact and is in close proximity to the cathode case. After, the aluminum completely oxidizes and appears to break the electrical contact between the inner and outer conductive layer leaving behind only the gasket 3009 and the insulating layer 3005 (FIG. 30D). The outer layer of the cathode case 3004 does not display any signs of corrosion. Traces of aluminum oxide powder 3010b can be seen gathering on the gasket and anode cup.

ii). Immersion in 25% Ringers Solution and DI Water

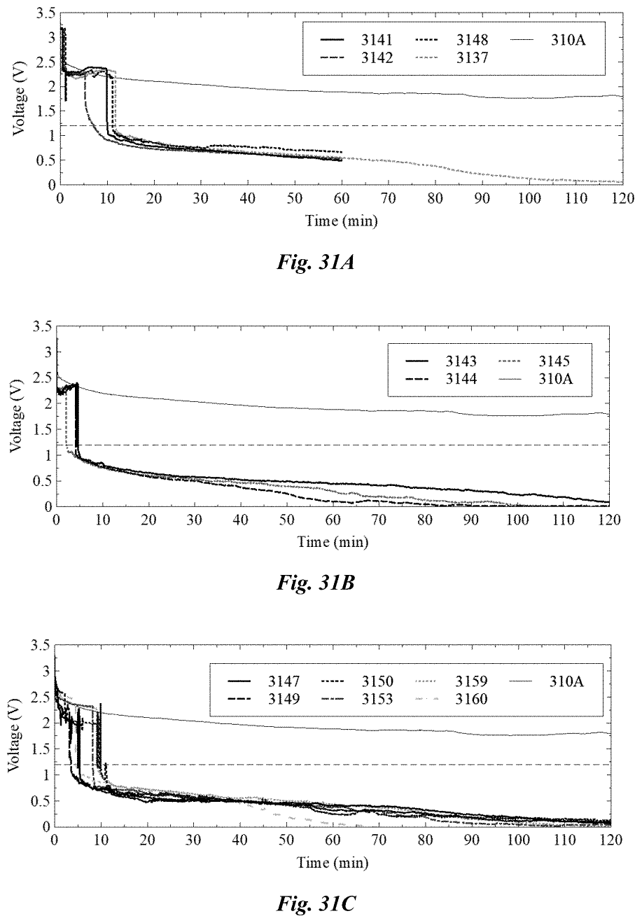

FIGS. 31A, 31B, and 31C show voltage versus time after immersion in 25% Ringers solution. A Maxell commercial control, 310A, is plotted in each graph as a reference for untreated cells. The voltage was measured and recorded using a Graphtec Data logger GL240 (Graphtec America, Inc.). Titanium metal ribbon leads were attached to each terminal of the battery using a clip to hold the leads and battery in place. The battery, leads, and clip were fully immersed in 20 mL of 25% Ringers solution at room temperature to start the experiment. The results are summarized in Table 2.

TABLE 2
The duration of time for exemplary batteries to drop below 1.2V in 25% Ringers
Solution and other voltage and pH measurements.

| | Exemplary | Al layer | Time to | Voltage | Voltage | |
|---|---|---|---|---|---|---|
| Run | battery | thickness | drop below | after | after | pH after |
| ID | embodiment type | (μm) | 1.2 V (min) | 1 hr (V) | 2 hr (V) | 2 hr |
| 3137 | Double-fold | 9 | 11.8 | 0.544 | 0.058 | 6 |
| 3141 | Double-fold | 9 | 10.0 | 0.495 | — | — |
| 3142 | Double-fold | 9 | 7.1 | 0.528 | — | — |
| 3148 | Double-fold | 9 | 11.1 | 0.666 | — | — |
| 3143 | Double-fold | 5 | 4.3 | 0.450 | 0.099 | 6 |
| 3144 | Double-fold | 5 | 4.2 | 0.097 | 0.009 | 5 |
| 3145 | Double-fold | 5 | 2.1 | 0.302 | −0.025 | 5 |
| 3147 | 4-tab | 9 | 5.0 | 0.409 | 0.062 | 5 |
| 3149 | 4-tab | 9 | 3.5 | 0.316 | 0.104 | 5 |
| 3150 | 4-tab | 9 | 9.6 | 0.244 | 0.137 | 5 |
| 3153 | 4-tab | 9 | 8.2 | 0.372 | 0.043 | 5 |
| 3159 | 4-tab | 9 | 9.1 | 0.435 | −0.004 | 5 |
| 3160 | 4-tab | 9 | 4.6 | 0.372 | −0.107 | 5 |
| 310A | Commercial | N/A | — | 1.885 | 1.794 | 12.5 |
| | Control | | | | | |
| 310B | Commercial | N/A | — | 2.099 | 1.958 | 12.5 |
| | Control | | | | | |

The results of four exemplary batteries, specifically the double-fold example with an Al layer thickness of 9 μm described further in example 3, and one commercial control CR2032 are shown in FIG. 31A. The voltage of the prototype cells drops to less than 1V in under 15 minutes, with an average time to drop below 1.2V of 10(+/−3) minutes. The duration for the voltage to drop below 1.2V can be shortened by building the prototype with a thinner Al layer. FIG. 31B shows three exemplary batteries, specifically the double-fold embodiment with an Al layer thickness of 5 μm described further in example 3. The average time to drop below 1.2V is 3.5(+/−1.2) minutes. In FIG. 31C, six exemplary batteries, specifically the 4-tab embodiment with an Al layer thickness of 9 μm described further in example 4, were run under the same conditions. The time for the voltage to drop below 1.2V is 7(+/−3) minutes. This suggests that the duration until the voltage drop can be reduced by decreasing the amount of exposed Al layer in the bridge. The pH for all of the treated prototypes cells were in the 5-6 pH range after 2 hours of being immersed in solution.

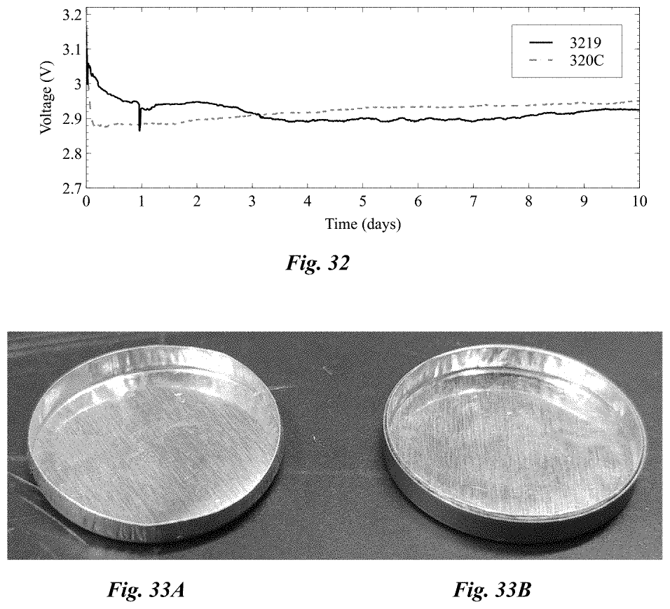

To test the stability of the treated cells under cleaning conditions similar to cleaning procedures to which commercial batteries are subjected, an exemplary battery, specifically a double-fold embodiment with a 9 μm Al layer, (3219) and a commercial control cell (320C) were immersed in deionized water (18 MΩ-cm) for 10 days at room temperature (FIG. 32). The voltage of each battery dropped slightly presumably since the resistance of deionized water is not infinite. Over the course of the 10 days, both cells maintained a voltage around 2.9 V. Small amounts of red corrosion product were visible by eye on the commercial control cell and a small amount of white corrosion product could be seen on the double-fold prototype cell. Some corrosion may be observed because the high resistance of the deionized water may reduce the rate of electrolysis but may not stop electrolysis completely. However, this corrosion did not prevent the cells from maintaining a similar voltage in DI water after 10 days.

In some commercial manufacturing processes, the cell is sprayed or immersed in a non-conductive aqueous medium shortly after assembly to presumably remove any excess material and/or solvent. Exemplary non-conductive aqueous mediums may include 18 Mohm-cm deionized water or non-ionic cleaning solutions with a resistivity greater than 1 Mohm-cm. The immersion in 18 Mohm-cm deionized water described above suggest that the exemplary battery may behave similarly to commercial batteries under cleaning conditions.

iii) Extended Immersion is 25% Ringers Solution

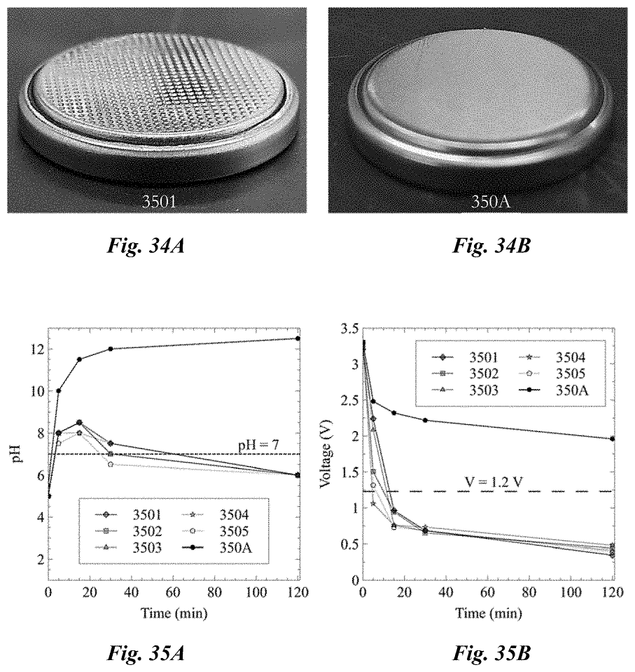

Five exemplary batteries, specifically the double-fold embodiments with a 9 μm Al layer, and one commercial Maxell control cell were immersed in 15 mL of 25% Ringers solution for at least 14 days. An image of the double-fold insert and the double-fold insert inside of a CR2032 stainless steel cathode case are shown in FIGS. 33A and 33B respectively. A fully assembled, double-fold exemplary battery (sample 3501) can be seen in FIG. 34A next to the commercial control (sample 350A) at the start of the experiment in FIG. 34B. The electrical performance of the batteries and the pH of the solutions directly above the anode were measured for the first 120 minutes after immersion. The visual observations and electrical performance were measured again after the cells were removed from the solution after at least 14 days.

All five example cells, 3501 through 3505, followed a similar pH curve during the first 120 minutes of the experiment (FIG. 35A). The starting pH of the 25% Ringers solution was 5-5.5. After 5 minutes, the pH of the example cell solutions rose to 7.5-8 and peaked at 8-8.5 at 15 minutes. The pH then steadily dropped for the remaining 120 minutes to below 7. The pH of the commercial control (350A) solution rose to 11.5 after 15 minutes and continued to climb to 12.5 after 120 minutes.

Shown in FIG. 35B, the voltage of all the example cells, 3501 through 3505, drops below the 1.2V after 15 minutes. This also corresponded with a drastic decrease of effervescence observed on the anode at this time. The commercial control, 350A, maintained a voltage above 1.75 V and active effervescence after 120 minutes.

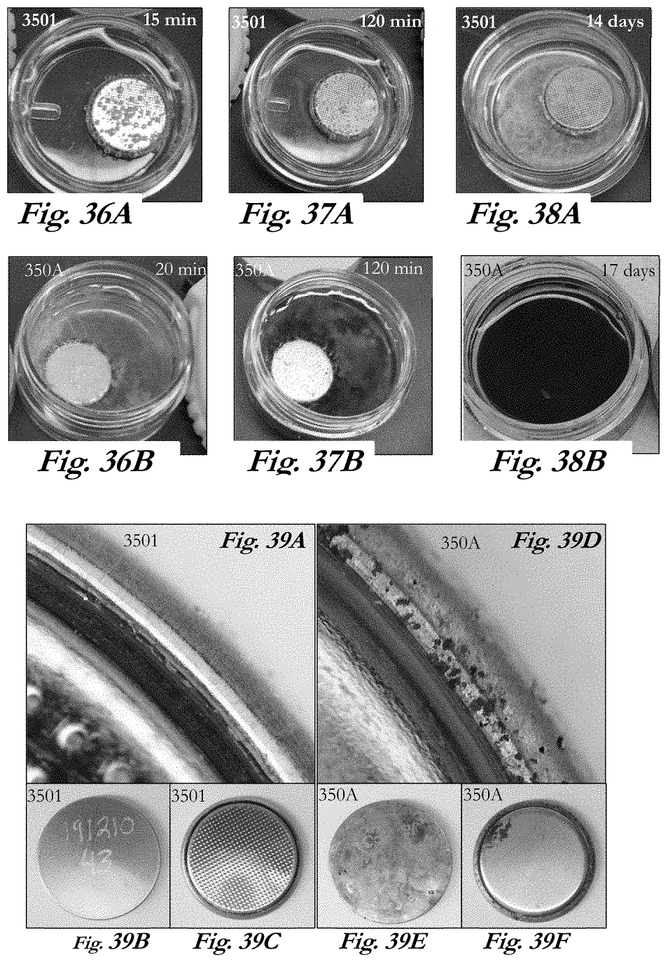

The progression of the reaction can be seen in FIGS. 36, 37 and 38 with FIGS. 36A, 37A, and 38A showing sample 3501 and FIGS. 36B, 37B, and 38B showing sample 350A. After 15 and 20 minutes for sample 3501 and the commercial control 350A respectively, a brown corrosion product is visible in the solution of the commercial cell compared to the clear solution of the treatment cell (FIG. 36). After 120 minutes (FIG. 37) and at least 14 days (FIG. 38), the distinction between the reaction products of the example cells and control cells becomes more visually apparent.

After at least 14 days, the cells were removed and cleaned in 18 MΩ-cm deionized water with light brushing to remove excess solids. FIG. 39 shows closeup images of the double-fold prototype sample 3501 (FIGS. 39A, 39B and 39C) taken by a Dino-lite digital microscope. All of the double-fold prototype cells looked similar to this sample with no signs of pitting or corrosion on either the anode cup or cathode can. As shown in the commercial control 350A images (FIGS. 39D, 39E, and 39F), there is excessive pitting and corrosion on the cathode can. All of the samples, including the control, slightly increased in mass after being immersed for two-weeks. The mass change did not exceed a 0.5% change of the mass of the cell. The commercial control was likely able to maintain a similar mass by gaining mass through forming a corrosion product that remained on the surface of the anode and cathode can and losing mass from the corrosion product breaking away from the cell.

TABLE 3
Physical and Electrical Measurements of Commercial and Exemplary
Batteries after long term immersion in 25% Ringers Solution.

| | | Mass | Mass | OCV | 15k_C | 3.9k_C | 1k_CC | pH of |
|---|---|---|---|---|---|---|---|---|
| Sample | Days | (g) | Change (g) | (V) | CV (V) | CV (V) | V (V) | solution |
| 350A | 0 | 2.948 | — | 3.312 | 3.306 | 3.289 | 3.23 | 5.5 |
| | 17 | 2.963 | 0.015 | −0.003 | 0 | 0 | 0 | Not |
| | | | | | | | | measured |
| 3501 | 0 | 2.795 | — | 3.206 | 3.193 | 3.158 | 3.048 | 5 |
| | 14 | 2.805 | 0.010 | 0.001 | 0 | 0 | 0 | 6 |
| 3502 | 0 | 2.812 | — | 3.296 | 3.286 | 3.255 | 3.161 | 5 |
| | 14 | 2.825 | 0.013 | 2.701 | 0.022 | 0.005 | 0.001 | 6 |
| 3503 | 0 | 2.735 | — | 3.268 | 3.239 | 3.157 | 2.856 | 5 |
| | 14 | 2.741 | 0.006 | 0.033 | 0 | 0 | 0 | 5.5 |
| 3504 | 0 | 2.715 | — | 3.276 | 3.182 | 2.474 | 1.866 | 5 |
| | 14 | 2.723 | 0.008 | 0.001 | 0 | 0 | 0 | 6 |
| 3505 | 0 | 2.733 | — | 3.238 | 3.227 | 3.194 | 3.101 | 5 |
| | 14 | 2.743 | 0.010 | 0.524 | 0.001 | 0 | 0 | 6 |

In Table 3, the open circuit voltage (OCV) as well as the closed circuit voltage (CCV) under 15 kohm for 5 seconds (15 k_CCV), 3.9 kohm for 5 seconds (3.9 k_CCV), and 1 kohm for 1 second (1 k_CCV) loads is recorded before and after immersion. The lab-made prototype cells have a higher variability in initial electrical performance since they were made in a lab and not on a commercial line. After immersion, all of the cells have a very high internal resistance and are incapable of carrying a load of 15 kohm with any significant voltage. The only cell to read an OCV over 1.2 V is sample 3502. This could be due to a very high resistance pathway still intact after immersion facilitated by some remaining solution. The resistance is large enough to not allow electrolysis of the conductive aqueous medium to take place. When sample 3502 was remeasured after three days drying on the bench top, the OCV read 0.018 V. The commercial cell also could not maintain a voltage with a 15 kohm load, but this is likely due to the capacity being drained as the cell continued to react with the solution to form hydroxide ions and the internal chemistry eventually being exposed to solution.

In the prototype samples, a small amount of white precipitate is formed after 15 minutes which becomes more apparent as the sample is immersed in solution for longer periods of time (FIGS. 36, 37, and 38). Each solution with the precipitate was collected after at least 14 days and analyzed by inductively coupled plasma—optical emission spectrometry (ICP-OES). The results, shown in Table 4, show very high levels of Al in the solution for all of the prototype cells, suggesting that the white solid seen in the prototype samples is an aluminum-based species, most likely Al(OH)₃. The white precipitate likely becomes more prevalent as time passes as the soluble complex ion [Al(OH)₄]⁻, which is stable in hydroxide rich environment (basic), crashes out of solution forming the less soluble Al(OH)₃ product as the pH drops and the system reaches equilibrium.

TABLE 4
ICP-OES Analysis of the solutions from the Commercial and Exemplary
Batteries experiments after long term immersion in 25% Ringers Solution.

| ICP-OES | | | | | | |
|---|---|---|---|---|---|---|
| Units | μg/L | μg/L | μg/L | μg/L | μg/L | μg/L |
| Metals | Fe | Cr | Li | Mn | Ni | Al |
| Sample Solutions | | | | | | |
| 350A (Commercial) | 3746000 | 721200 | 816800 | 29460 | 273600 | 5951 |
| 3501 | 874 | 35 | 50 | 26 | 30 | 149100 |
| 3502 | 1108 | 78 | 13 | 26 | 60 | 165800 |
| 3503 | 697 | 19 | 14 | 16 | 18 | 118200 |
| 3504 | 889 | 29 | 10 | 65 | 26 | 154900 |
| 3505 | 893 | 22 | 10 | 21 | 23 | 170900 |
| 25% Ringers Solution | 32 | ND | 8 | ND | ND | 315 |
| (Background) | | | | | | |
| PQL | 100 | 5 | 10 | 5 | 5 | 100 |
| LOD | 25 | 1.25 | 5 | 1.25 | 1.25 | 25 |

PQL = Practical Quantitation Limit;
LOD = Limit of Detection;
ND = No Detection

The solution from the commercial control contained high concentrations of elements expected from the corrosion of stainless steel such as Fe, Ni, and Cr. The control also had very high levels of Mn and Li which likely came from the internal contents breaching the cell after the casing became compromised. The prototype cells had extremely low levels of Li and Mn suggesting that the internal contents of the cell did not spill out into the solution.

iv.) Resistance of the Aluminum and Stainless Steel Electrical Junction During Elevated Temperature and High Humidity Testing of the Double-Fold Embodiment

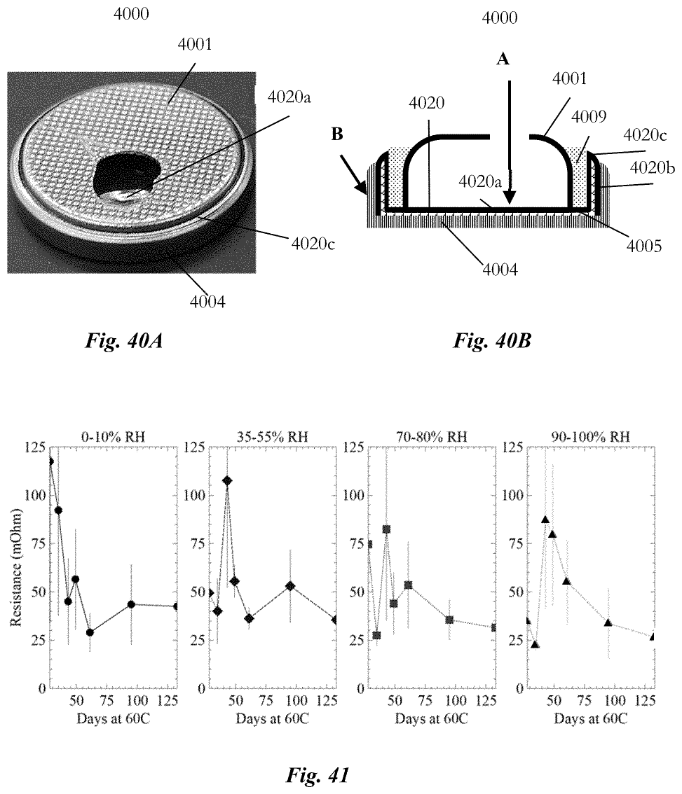

Double-fold laminate inserts 4020, as described in FIG. 33A, were placed into a 304 stainless steel cathode can 4004 and sealed with a commercial anode cap 4001 and gasket 4009 to form empty double-fold samples 4000. The anode cap 4001 was predrilled with a hole in the top to allow a resistivity probe to fit through to access the Al inner conductive layer 4020 before sealing (FIG. 40A). The samples were placed in four different environments: about 60° C. with 0-10% relative humidity (RH), about 60° C. with 35-55% relative humidity, about 60° C. with 70-80% relative humidity, and about 60° C. with 90-100% relative humidity. The resistivity was measured with a milliohm meter using a 4-probe resistivity method at select time intervals over the course of 133 days. The resistivity measurements were between points A and B, as indicated in FIG. 40B. The A to B pathway is from the inner conductive layer 4020a, extended over the rim 4020c, and electrically connected to the outer conductive layer 4020b to form the bridge to the stainless steel cathode can 4004. As shown in FIG. 41, all of the samples remain under 0.12 ohm during the entire 133 days at 60° C. and all tested RH conditions. There were no visible signs of degradation of the Al inner conductive layer or the stainless steel casing.

How long a battery can be stored without losing its specified performance is considered the battery's shelf life stability. One can measure the shelf-life stability by storing the product under normal storage conditions, and then routinely measuring the product performance. Alternatively, in some battery testing procedures, the shelf-life stability may be estimated by measuring the performance of the cell at about 60° C. with about 90% relative humidity. Twenty days under these conditions may approximate 1 year under ambient temperature and humidity. An approximated shelf life of 1 year or greater is advantageous in terms of mass production and manufacturability. The experiment above suggests that the exemplary battery cathode case may not undergo corrosion after storage for 133 days in an environment having a temperature of about 60° C. and about 90-100% relative humidity. Other experiments, such as Example 1bii, suggest that the same exemplary battery cathode case may deactivate in a conductive aqueous medium in a duration ranging from about 5 to about 15 minutes. The possible short deactivation time in a conductive aqueous medium in addition to the suggested stability at about 60° C. with about 90% relative humidity may be a unique aspect to this exemplary battery case design.

v) Exposure to Hydrated Porcine Esophageal Tissue

Commercial Maxell CR2032 control, lab-made control, and treatment example batteries were placed in porcine esophageal tissue and examined for changes in appearance and signs of visual damage. The frozen porcine esophageal samples were thawed in room temperature water for 12 hours before use, then rinsed with artificial saliva and placed in an artificial saliva bath at 37° C. The porcine esophageal tissue was cut into about 7 cm segments and the tubular samples were cut along the long axis to open the tissue to a flat sheet. The tissue samples were kept in the artificial salvia bath until the start of the experiment. Next, the batteries were placed with the anode facing down on the bottom layer of a segment of tissue, then the drip irrigation hose was placed on top of the esophagus section, and finally the tissue was folded over secured by a clamp to the irrigation board. The drip irrigation was set to 10 mL/15 min of 37° C. artificial saliva. About every 15 minutes, the clip was opened and the tissue was photographed for a total duration of 4 hours. Attempts to measure pH resulted in irregular and variable values, most likely due to the continuous flow of artificial saliva.

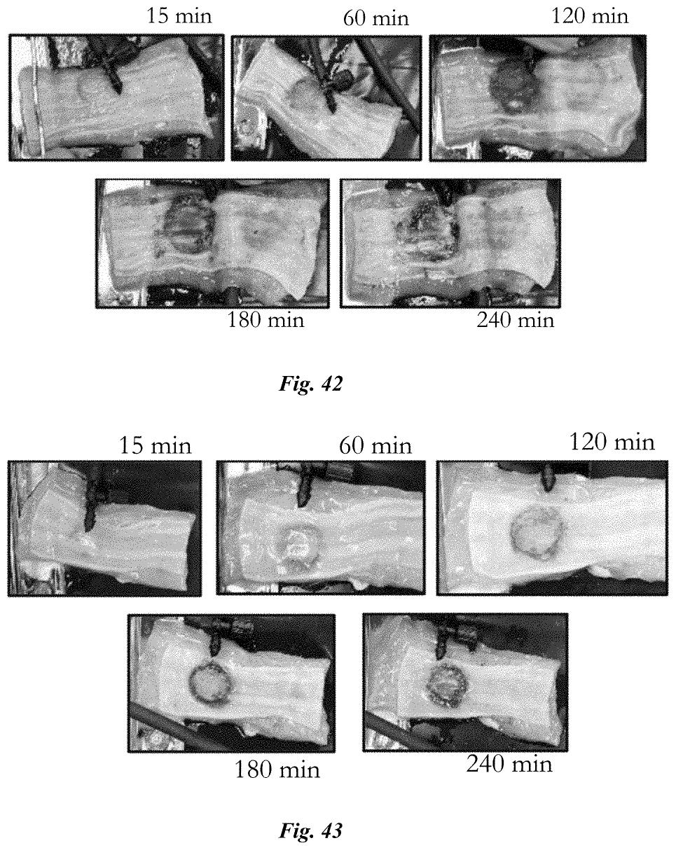

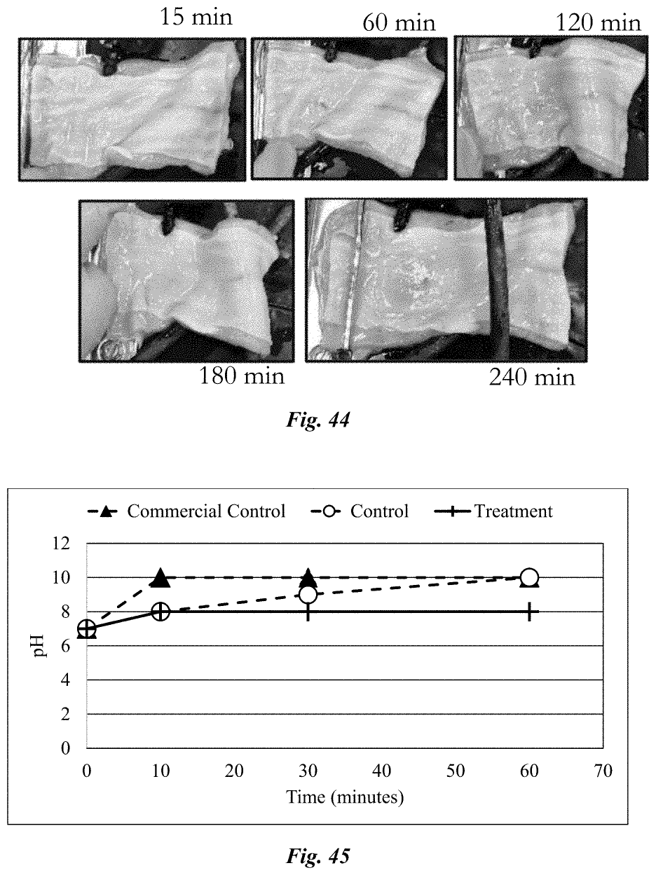

Exposure of the tissue to the lab-made control batteries resulted in a slower increase in visual damage compared to exposure to the commercial control, likely because of differences in impedance between the batteries (the impedance of the lab-made batteries is consistently more than twice that of the commercial control batteries). Despite these differences, the commercial control and the lab-made control began showing signs of visual damage within 60 minutes (FIGS. 42 and 43). After 240 minutes, the tissue for both control batteries show visual signs of necrotic tissue that is especially drastic on the tissue exposed to the gap between the anode and the cathode. By contrast, the visual damage of the esophageal tissue appeared minimal after 240 minutes of exposure to the treatment example battery (FIG. 44).

vi) Exposure to Hydrated Ham

Exposure of commercial Maxell CR2032 lithium control, lab-made control, and exemplary batteries to a slice of ham showed similar trends as seen in the saline immersion test. The ham samples were initially hydrated with about 3 ml of 0.85% saline solution in a shallow petri dish and the cells were placed with the anode facing down on the bottom layer of the ham. The slice of ham was folded over to cover the cell and a weight of 500 g was pressed on top of the ham. pH of the ham in direct contact with the center of the anode case was measured at 0, 10, 30 and 60 minutes by gently unfolding the ham, moving the battery aside, and touching pH paper strips to the ham where the center of the anode case had been. The battery was returned to the initial position after each measurement. FIG. 45 is a plot of pH of the surface of the ham under the anode versus exposure time to each of the batteries. The pH of the ham rose from 7 to 10 after exposure to both commercial Maxell CR2032 lithium battery and lab-made control samples. Similar to the esophageal tissue test, exposure of the ham to the lab-made control sample resulted in a slower increase in the pH compared to exposure to the commercial control, likely because of differences in impedance between the batteries (the impedance of the lab-made control batteries are consistently more than twice that of the commercial control batteries). Although differences in impedance impacted the rate of the pH increase, the ham had a pH of 10 at the 60 minute mark after exposure to both the lab-made control cell and the commercial cell. By contrast, the pH of the ham remained consistently at a pH of 8 up to 60 minutes after exposure to the treatment example battery.

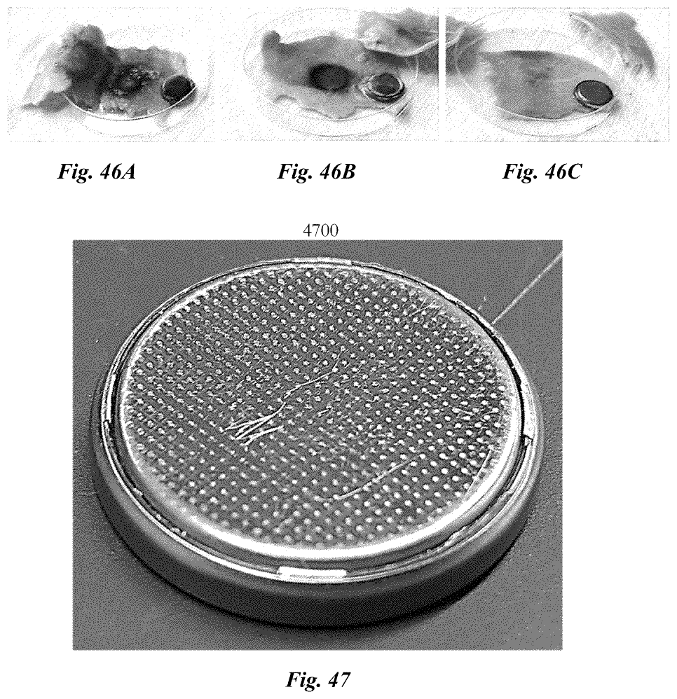

The 60-minute time point photographs displayed in FIGS. 46A to 46C show critical differences in the appearance of the ham. The commercial Maxell CR2032 lithium battery and lab-made control batteries have a green and black precipitate and discoloration of the ham that is most heavily concentrated near the gap between the anode case and cathode case (FIGS. 46A and 46B). This precipitate and ham discoloration is likely due to corrosion byproducts from the reacting cathode case during electrolysis. Also, the tissue in direct contact with the anode case, where increasing pH is most concentrated, became semi-transparent with a slight orange tint. In contrast, the treatment example battery (FIG. 46C) showed only a minimal amount of green and black precipitate and ham discoloration.

### Example 2

A. Exemplary Materials Used in Examples 2-10 are Listed Below:

1. Exemplary Foil and Foil Laminate Materials

Aluminum alloy 1100 temper O at a thickness of 9, 12.5, 17.5 and 25 microns (μm) wrapped around Aluminum alloy 1235 temper O at a thickness of 9, 12.5, 17.5 and 25 microns Wrapped around. Aluminum foil laminate with foil layer of 1145 aluminum foil at 8.89 micron thickness laminated to polyethylene terephthalate polymer film at 12.5 micron thickness (48 ga) with thermoset laminating adhesive epoxy based, 2 part formulation with varying cross-linker concentrations (brand name Lamart MF100).

Aluminum foil laminate with foil layer of 1145 aluminum foil at 8.89 micron thickness laminated to polyetherimide ULTEM film at 12.5 micron thickness (48 ga) with thermoset laminating adhesive epoxy based, 2 part formulation with varying cross-linker concentrations.

2. Exemplary Thermoform Film Materials

Polymer material was thermoformed into plastic liner cups for the insulation layer. Example polymers used for this process include polyethylene terephthalate (brand name Mylar) at 36 μm, 50 μm thickness, polyetherimide (brand name ULTEM and Kapton) at 25 μm and 50 μm, perfluoroalkoxy polymer film, fluorinated ethylene propylene film and polyvinylidene fluoride film at 25 μm and 50 μm thickness.

3. Exemplary Outer Cathode can Substrate Materials

The cathode “can” in the examples refers to the thicker stainless steel layer that typically makes up the outer conductive layer.

The cathode “case” refers to the whole cathode case construction, which includes the cathode can and any inserts affixed to the cathode can.

Cathode can substrates were made out of stainless steel SS304 or SS430 at 20 μm, 225 μm or 250 μm thickness.

The abo % e substrate materials were then stamped to specific dimensions designed to fit a CR2032 battery assembly to cover and crimp in an anode cup which will house the active portion of the coin cell.

B. PVD 3-8 Micron Al Layer on ULTEM Thermoform Cup Prototype

A schematic depicting the manufacture of a battery in accordance with this example is depicted in FIGS. 18A and 18B. Sheets of 25 and 50 μm ULTEM (polyetherimide) were thermoformed into cup inserts 1805. An internal conductive layer 1820 was formed by depositing a 3-8 μm Al coating on the ULTEM thermoform cups using physical vapor deposition (“PVD”). The ULTEM thermoform does not warp and maintains its size and shape after going through the PVD process. The 36 μm PET thermoform cup samples were coated with the same Al PVD process, but the walls of the PET cup warped yielding a less desirable fit. The Al coating covered the entire inside of the cup 1820a, the rim of the cup 1820c, and the top 50% of the outside wall of the cup to form a continuous layer 1820b. The resistance of the thermoform was less the 1 ohm from the center inside of the cup to the outer wall as measured by a milliohm meter. The Al coated ULTEM thermoform was then placed inside a stainless steel (in this experiment, SS304 was used) cathode can 1804 with a thickness of 200 μm or 250 μm. The thermoform can be placed into the cathode can as a press fit or may be secured by applying an adhesive on the bottom face of the thermoform 1805. The cathode case was then assembled into a CR2032 coin cell battery. The height of the PVD coated thermoform was between 2.3-2.8 cm so that the rim of the thermoform 1820c was visible around the entire rim edge after crimping. The thermoform was advantageously tall enough so that no portion of the bridge was buried under the gasket but not so tall as to contact the anode case.

When immersed in 0.85 wt % saline solution, the exposed Al coated around the rim edge of the cathode oxidized to greatly increase the resistance of the battery and stop the electrolysis of the saline solution. The deactivation time ranged from 30 sec to 4 mins based on the thickness of the Al PVD coating and the height of the exposed Al layer as show % n in Table 5.

TABLE 5
The physical properties and deactivation times for Al PVD example
batteries.

| | | | Cathode Can | | |
|---|---|---|---|---|---|
| SS304 | | | with PVD | | |
| Cathode | Total PVD | | thermoform | | |
| Can | thermoform | PVD | insert | Initial | Time to |
| Thickness | thickness | Thermoform | resistance | OCV | Deactivate |
| (mm) | (mm) | Mass (g) | (mohm) | (V) | (mins) |
| 0.250 | 0.054 | 0.033 | 37 | 2.96 | 4.0 |
| 0.250 | 0.055 | 0.032 | 22 | 2.97 | 2.0 |
| 0.250 | 0.047 | 0.031 | 26 | 3.08 | 0.8 |
| 0.250 | 0.052 | 0.033 | 21 | 2.98 | 2.0 |
| 0.200 | 0.052 | 0.0029 | 27 | 3.03 | 0.5 |
| 0.200 | 0.053 | 0.030 | 32 | 3.07 | 1.0 |
| 0.200 | 0.064 | 0.033 | 38 | 2.97 | 2.0 |
| 0.200 | 0.058 | 0.034 | 42 | 3.01 | 3.5 |
| 0.200 | 0.052 | 0.032 | 30 | 3.05 | 1.0 |
| 0.200 | 0.051 | 0.031 | 67 | 2.97 | 2.0 |

### Example 3. Laminate Double-Fold Insert with Full Flange Folded Down Prototype

A schematic depicting the manufacture of a battery in accordance with this example is depicted in FIG. 21. A photograph of the insert is shown in FIGS. 33A and B, and a completed prototype is shown in FIG. 34 An Al 9 μm and PET 12.5 μm laminate (Lamart Corp MF100 Al 9 μm and PET 12.5 μm laminate joined by a laminating adhesive) was stamped into the shape described in FIG. 22A. The laminate was fed into a progressive die that blanked, cupped, qualified, and trimmed the insert. In the next series of stamping steps, the flange on the rim was folded down to produce the desired shape. The Al side of the laminate 2120 faced 2120a the inside of the cup. The flange was folded over at the rim 2120c to create a continuous Al layer from the inside of the cup to the outer walls 2120b. The double-folded 2120b spans the entire length of the side wall to keep wall thickness the same throughout. The bottom of the laminate cup is the PET side 2105. The MF100 double-fold insert was then placed inside a 200 μm SS304 cathode can 2104. The insert can be placed into the cathode can 2104 as a press fit or may be secured with an adhesive on the bottom face between 2105 and 2104 to form the cathode case. The cathode case was then assembled into a CR2032 coin cell battery. The height of the MF100 double-fold insert was between 2.3-2.8 cm, so the top of the Al fold 2120c is visible around the entire rim edge after crimping. The insert is advantageously tall enough so that no portion of the bridge is buried under the gasket but not so tall as to contact the anode case

As in previous samples, when immersed in 0.85 wt % saline solution, the exposed Al foil around the rim edge of the cathode 2119c oxidized to greatly increase the resistance of the battery and stop the electrolysis of the saline solution. The deactivation time ranges from 3-20 mins based on the height of the exposed Al foil fold.

### Example 4. Laminate 4 Tab Insert and Thermoform Support Prototype

Schematics depicting the manufacture of a battery according to this example are shown in FIGS. 22A and 22B A photograph of a completed prototype is shown in FIG. 47. An Al 9 μm and PET 12.5 μm laminate. MF100 produced by Lamart Corporation, was stamped into the shape described in FIG. 22A. The laminate was fed into a progressive die that blanked, cupped, qualified, and trimmed to produce the 4 tab design. The Al side of the laminate 2220 faced the inside of the cup 2220a where the PET side was on the bottom of the cup 2205a. The 4 tab MF100 cup was placed inside a 36 μm PET thermoformed cup 2205b as a press fit or may be secured with an adhesive on the bottom face. A small amount of adhesive was applied to the PET side of the tabs 2220e and the tabs were folded down and secured to the PET thermoformed cup 2205b. The insert can be placed into the cathode can 2204 (200 μm SS304 or 250 μm SS304) as a press fit or mas be secured with an adhesive on the bottom face 2205b to form the cathode case. The cathode case was then assembled into a CR2032 coin cell battery. The height of the insert was between about 2.3-2.8 cm so that the exposed Al from the tabs 2220c is visible around rim edge after crimping. The insert is advantageously tall enough so that no portion of the bridge is buried under the gasket but not so tall as to contact the anode case.

As in previous samples, when immersed in 0.85 wt % saline solution, the exposed Al foil around the rim edge of the cathode oxidized to greatly increase the resistance of the battery and stop the electrolysis of the saline solution. The deactivation time ranged from 3-10 mins based on the height and thickness of the exposed Al foil fold.

### Example 5. Al Foil 4 Tab Insert and Thermoform Insulating Support Prototype

An Al foil was stamped into the shape described in FIG. 22A to form the cup 2222 shown in FIG. 22C. The thickness of the Al foil can range from 12.5-25 μm. In this example. Al foils of 12.5 μm and 25 μm were used. The foil was fed into a progressive die that blanked, cupped, qualified, and trimmed to produce the 4 tab design. The 4 tab Al cup 2222 was placed inside a 36 μm PET thermoformed cup 2205 by either a press fit or by applying adhesive between the two layers. A small amount of adhesive was applied to the PET side of the tabs 2222e and the tabs were folded down and secured to the PET thermoformed cup 2205 to form the insert. The insert can be placed into the cathode can 2204 as a press fit or may be secured with an adhesive on the bottom face of the PET thermoformed cup 2205 to form the cathode case. The cathode case was then assembled into a CR2032 coin cell battery. The height of the insert is between 2.5-2.8 cm so that the exposed Al from the tabs 2222c is visible around rim edge after crimping. The insert is advantageously tall enough so no portion of the bridge is buried under the gasket but not so tall as to contact the anode case.

As in previous samples, when immersed in 0.85 wt % saline solution, the exposed Al foil around the rim edge of the cathode oxidizes to greatly increase the resistance of the battery and stop the electrolysis of the saline solution. The deactivation time ranges from 3-20 mins based on the height and thickness of the exposed Al foil fold.

### Example 6. Laminate 4 Tab Insert and Channeled Cathode can Prototype

As depicted in FIGS. 23A and 23B, an Al 9 μm and PET 12.5 μm laminate (MF 100), was stamped into the shape depicted in FIG. 22A. The laminate was fed into a progressive die that blanked, cupped, qualified, and trimmed to produce the 4 tab design. The Al side of the laminate 2320a faced the inside of the cup. The 4 tab MF100 cup was placed inside a channeled 225 μm SS304 cathode can. The 4 tabs align with the cathode can channels 2330 and the tabs are folded to recess inside the channels. The depth of the channels ranged from 25-50 μm. This prevents the crimp die from making direct contact with the MF100 4 tabs as the tabs remain on the outside wall of the cathode can during the crimping process. The insert can be secured as a press fit or may be secured by applying an adhesive on the bottom face of the thermoformed cup 2305 as well as the back side of the tabs. The tabs were electrically connected to the stainless steel cathode can with a low temperature solder 2331 completing the electrical connection between the inside and outside of the cathode case. The cathode case was then assembled into a CR2032 coin cell battery.

When immersed in 0.85 wt % saline solution, the exposed Al foil from the 4 extended tabs oxidized to greatly increase the resistance of the battery and stop the electrolysis of the saline solution. The deactivation time ranged from 3-20 mins based on the width, length, and thickness of the exposed laminate tabs.

### Example 7. Al Foil 4 Tab Insert and Channeled Cathode can Prototype

An Al 12.5 μm foil 2320 was stamped into the shape illustrated in FIG. 22A. The foil was fed into a progressive die that blanked, cupped, qualified, and trimmed to produce the four-tab design. As depicted in FIGS. 23C and 23D, the four-tab Al foil cup 2320 was placed inside a 36 μm PET thermoformed cup 2321 and secured by either a press fit or an adhesive between the lavers to form the insert. The cathode can was a 225 μm SS304 cathode can with recess channels for the tabs. The four tabs aligned with the cathode can channels 2330 and the tabs were folded to recess inside the channels. This prevented the crimp die from making direct contact with the four tabs as the tabs remain on the outside wall of the cathode can during the crimping process. The insert can be secured as a press fit or may be secured by apply ng an adhesive between the bottom face of the thermoformed cup 2321 and the stainless steel cathode can 2304. The tabs are secured with a low temperature solder 2331 (S-Bond 220), which formed the electrical connection between the inside and outside of the cathode case. Alternatively, the tabs could be secured to the outer cathode can with a conductive adhesive such as silver epoxy (Creative Materials). The cathode case is then assembled into a CR2032 coin cell battery.

When immersed in 0.85 wt % saline solution, the exposed Al foil from the 4 extended tabs oxidized to greatly increase the resistance of the battery and stop the electrolysis of the saline solution. The deactivation time ranged from 3-20 mins based on the width, length, and thickness of the exposed Al foil tabs.

### Example 8. Trilaminate with Adjusted Crosslinker Levels Prototype

A tri-laminate material according to FIGS. 14 and 15 was created by laminating MF100 (Lamart Corp MF100 (Al 9 μm and PET 12.5 μm laminate joined by a laminating adhesive) to a sheet of fully annealed draw quality 200 μm, 225 μm, and 250 μm SS304. A laminating adhesive with a crosslinker was used to join the materials. The amount of crosslinker was optimized to obtain strong adhesion while also maintaining flexibility so the material could be stamped without delaminating. If the crosslinking level was too high, the laminating adhesive became brittles and delaminated during the stamping process, especially along the walls of the can where the material is drawn the deepest.

The tri-laminate was stamped into the cathode can. The bridge was formed by pinching the Al foil layer into the SS304 outer cathode can during the crimping process. The bridge can be further secured by using solder or ultrasonic welding to help join the Al SS304 before or after the crimping step.

As in previous samples, when immersed in 0.85 wt % saline solution, the exposed Al foil around the rim edge of the cathode oxidized to greatly increase the resistance of the battery and stop the electrolysis sis of the saline solution. The deactivation time ranged from 3-20 mins based on the amount and thickness of the exposed Al foil.

### Example 9. SS304 and Kapton Laminate that is PVD Coated Prototype

A to layer laminate of fully annealed, draw quality SS304 sheet roll and Kapton (PEI) film were joined by a laminating adhesive. The thickness combinations include 200 μm SS304/50 μm Kapton, 225 μm SS304/25 μm Kapton, and 250 μm SS304/25 μm Kapton. The amount of crosslinker was optimized to obtain strong adhesion while also maintaining flexibility so the material could be stamped without delaminating. If the crosslinking level was too high, the laminating adhesive became brittle and delaminated during the stamping process, especially along the walls of the can where the material is drawn the deepest

The Kapton/SS304 laminate was then stamped into cathode cans and a 3-10 μm layer of Al was deposited by PVD. The ULTEM layer did not warp and maintained its size and shape after going through the PVD process and the laminating adhesive maintained the bond between the stainless steel and Kapton layers.

### Example 10. Dykor Encapsulation Prototype

Starting with a 200 μm stainless steel cathode can, about a 50-100 μm layer of Dykor is coated as the insulating layer (similar to that exemplified in FIG. 13G). The cathode can is uniformly coated on the inside of the can, the inner walls, over the rim of the can, and partially over the outer wall of cathode can, to form a continuous layer. The Dykor coating can be reinforced with fiberglass to increase maximum service temperature and abrasion resistance. The sample is then metallized to form about a 200 rim to about a 25 μm thick Aluminum PVD coating (FIG. 13G).

### EQUIVALENTS

The foregoing written specification is sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

1. A battery comprising:
an anode case;
a cathode case comprising an inner conductive layer, an outer conductive layer, and an insulating layer between the inner and the outer conductive layers,
an electrochemical cell comprising an anode, a cathode, and a separator positioned between the anode and the cathode; and
a gasket between the anode case and the cathode case;
wherein the inner and the outer conductive layers are in electrical contact through at least one bridge.

2.-131. (canceled)
